(19) United States
(12) Patent Application Publication
(10) Pub. No.: US 2025/0348339 A1
(43) Pub. Date: Nov. 13, 2025

(54) Memory Projection Techniques

(71) Applicant: Oracle International Corporation, Redwood Shores, CA (US)

(72) Inventors: Per-Ake Minborg, Stora Hoga (SE); Maurizio Cimadamore, Donabate (IE); Jorn Bender Vernee, Leiden (NL)

(73) Assignee: Oracle International Corporation, Redwood Shores, CA (US)

(21) Appl. No.: 18/952,002

(22) Filed: Nov. 19, 2024

Related U.S. Application Data
(60) Provisional application No. 63/645,800, filed on May 10, 2024.

(51) Int. Cl. G06F 9/455

(52) U.S. Cl. CPC G06F 9/45504; G06F 9/45558; G06F 2009/45583

(57) ABSTRACT

Techniques are disclosed for projecting information between runtime objects and memory regions. To this end, the system maps elements of a reference type to constituent layout objects of a compound layout object. Based on the mappings, the system determines a first method for extracting data from a source memory region described by the compound layout object and generating a target runtime object of the reference type to represent the extracted data in a runtime memory area that is managed by a garbage collector. Furthermore, based on the mappings, the system determines a second method for writing data represented by a source runtime object of the reference type to a target memory region in accordance with the compound layout object. The system subsequently uses the first method and/or the second method to project information between runtime objects of the reference type and memory regions corresponding to the compound layout object.

### BENEFIT CLAIMS; RELATED APPLICATIONS; INCORPORATION BY REFERENCE

This application claims the benefit of U.S. Provisional Patent Application 63/645/800, filed on May 10, 2024, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to techniques for projecting information between different formats and different data repositories.

### BACKGROUND

In computer science, an “abstraction” is a higher-level representation of information that focuses on important details while minimizing underlying complexity. Abstractions often simplify conceptualizing intricate systems by presenting essential properties while hiding underlying irrelevant details. For instance, at a low-level, memory is often implemented using groupings of binary digits. Low-level memory is also referred to colloquially as “flat memory,” “unstructured memory,” and otherwise. A binary digit (often referred to as a “bit”) is a basic unit of information that is used to represent binary data. In general, a bit represents one of two possible values, zero or one. Multiple bits can be combined to represent more complex values. Multiple bits are often abstracted into eight-bit quantities referred to as “bytes.” Bytes, in turn, serve as the building blocks for higher-level abstractions such as primitive types, reference types, objects, and other data structures. Abstractions allow higher-level programming constructs to interact with low-level memory without needing to manage the intricate details of data representation and manipulation directly. This enables developers to work with more intuitive data types and structures, improving code readability and maintainability.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example computing architecture in which techniques described herein may be practiced according to an embodiment;

FIG. 2 is a block diagram illustrating one embodiment of a computer system suitable for implementing methods and features described herein;

FIG. 3 illustrates an example virtual machine memory layout in block diagram form according to an embodiment;

FIG. 4 illustrates an example frame in block diagram form according to an embodiment;

FIG. 5 illustrates an example memory projection system according to an embodiment;

FIG. 6 illustrates example operations for mapping a reference type to a compound layout object according to an embodiment;

FIG. 7 illustrates example projection operations according to an example embodiment;

FIG. 8 illustrates example operations for projecting a record instance according to an example embodiment;

FIG. 9 illustrates example operations for projecting an internal interface object according to an example embodiment;

FIG. 10 illustrates example operations for projecting an external interface object according to an example embodiment; and

FIG. 11 shows a block diagram that illustrates a computer system according to an embodiment.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.

The following table of contents is provided for the reader's convenience and is not intended to define the limits of the disclosure.
1. GENERAL OVERVIEW
2. ARCHITECTURAL OVERVIEW
   2.1 EXAMPLE CLASS FILE STRUCTURE
   2.2 EXAMPLE VIRTUAL MACHINE ARCHITECTURE
   2.3 LOADING, LINKING, AND INITIALIZING
3. MEMORY PROJECTION SYSTEM
4. MAPPING A REFERENCE TYPE TO A COMPOUND LAYOUT OBJECT
5. EXAMPLE EMBODIMENT
   5.1 EXAMPLE PROJECTION OPERATIONS
   5.2 EXAMPLE OPERATIONS FOR PROJECTING A RECORD INSTANCE
   5.3 EXAMPLE OPERATIONS FOR PROJECTING AN INTERNAL INTERFACE OBJECT
   5.4 EXAMPLE OPERATIONS FOR PROJECTING AN EXTERNAL INTERFACE OBJECT
   5.5 EXAMPLE INFERENCES
6. HARDWARE OVERVIEW
7. MISCELLANEOUS; EXTENSIONS

### 1. General Overview

One or more embodiments (a) generate mappings between a particular blueprint for creating an abstraction that can represent a composite dataset and a particular format for storing a composite dataset in low-level memory and (b) determine, based on the mappings, methods for projecting composite datasets between abstractions conforming to the particular blueprint and regions in low-level memory organized according to the particular format. The system determines get method(s) for projecting composite datasets from low-level memory (i.e., flat memory, unstructured memory, etc.) to abstractions, set method(s) for projecting composite datasets from abstractions to low-level memory, and/or other methods. An example get method includes instructions for (a) extracting a composite dataset that is stored to low-level memory in accordance with the particular format and (b) generating an abstraction conforming to the particular blueprint to represent the composite dataset in higher-level operations. An example set method contains instructions for (a) compiling a composite dataset that is represented by an abstraction conforming to the particular blueprint and (b) writing the composite dataset to low-level memory in accordance with the particular format. Once the system has generated these methods, the system can apply these methods to efficiently translate composite data between (a) any abstraction conforming to the particular blueprint and (b) any region in lower-level memory organized according to the particular format.

One or more embodiments generate a mapper object that (a) maps a reference type to a compound layout object and (b) provides methods for projecting composite datasets between runtime objects associated with the reference type and regions of memory organized according to the compound layout object. A runtime object associated with the reference type can serve as an abstraction of a composite dataset. In particular, a runtime object associated with the reference type will contain multiple fields corresponding to elements of the reference type, and the multiple fields can carry individual abstractions of individuals datasets that make up a composite dataset. However, note that the reference types and runtime objects may correspond to a higher-level programming language, whereas the information stored to the regions of memory may be specified in other programming languages (e.g., lower-level programming languages). The system may bridge language barriers by using the compound layout object to model composite datasets in low-level memory. The compound layout object is a variety of a memory layout object. A memory layout object specifies a language-neutral format for describing data in a region of memory. The compound layout object is an abstraction of other memory layout objects referred to herein as “constituent layout objects.” Accordingly, a region of memory that is described by the compound layout object contains multiple subregions that are respectively described by the multiple constituent layout objects.

One or more embodiments create a mapper object that maps a reference type to a compound layout object by generating individual mappings between elements of the reference type and constituent layout objects of the compound layout object. The system uses reflection to identify the elements of the reference type, and the system maps an element of the reference type to a constituent layout object of the compound layout object based on matching attribute(s) of the element with attribute(s) of the constituent layout object. Based on the individual mappings, the system determines get methods and/or set methods that can project information between any runtime object associated with the reference type and any region of memory described by the group layout object. An example get method (a) extracts a composite dataset that is stored to a region of memory in accordance with the format specified by the compound layout object and (b) generates a runtime object associated with the reference type to represent the composite dataset in higher-level operations. An example set method (a) accesses a composite dataset that is represented by a runtime object associated with the reference type and (b) writes the composite dataset to a region of memory in accordance with the format prescribed by the compound layout object.

Based on mappings between elements of a reference type and constituent layout objects of a compound layout object, one or more embodiments create a mapper object that offers one or more methods for projecting information between runtime objects related to the reference type and regions of memory organized according to the compound layout object. To generate the methods that are offered by mapper objects, the system creates mechanisms for causing low-level operations. More specifically, the system creates mechanisms for causing low-level operations (e.g., reading, writing, etc.) in a region of memory that is organized according to the compound layout object. In an example, the system directly generates a set of instructions (e.g., intermediate instructions such as bytecode or other code constructs) for causing a low-level operation, and the system inserts that set of instructions into the instructions of a method that will be offered by the mapper object. In another example, the system generates a method handle object or another abstraction that can be used to trigger a low-level operation, and the system configures a method offered by the mapper object to use that method handle object to cause the low-level operation.

One or more embodiments generate, based on mappings between elements of a reference type and constituent layout objects of a compound layout object, method handle objects or other runtime objects that can be used to trigger low-level operations on regions of memory organized in accordance with the compound layout object. Once the system has generated method handle objects for the relevant mappings between the reference type and compound layout object, the system generates get method(s) for the mapper object, set method(s) for the mapper object, and/or other method(s) for the mapper object based on the method handle objects that the system generated for the mappings.

One or more embodiments generate, based on a mapping between an element and a constituent layout object, get method handle object(s), set method handle object(s), and/or other method handle objects. A get method handle object can be used to invoke a method that will (a) extract a dataset from a subregion of memory organized according to the constituent layout object and (b) store a value representing that dataset to an object field corresponding to the element. A set method handle object can be used to call a method that will (a) access a dataset represented by a value held by an object field corresponding to the element and (b) write that dataset to a subregion of memory in accordance with the constituent layout object. Note that the constituent layout object may, in turn, be another compound layout object (referred to herein as an “inner compound layout object”), and an inner compound layout object may possess a separate set of constituent layout objects. It should also be noted that if the constituent layout object is an inner compound layout object, the field will indicate another reference type (referred to herein as an “inner reference type”). In this scenario, the system generates another mapper object (referred to herein as a “child mapper object”) that maps the inner reference type to the inner compound layout object, and the system generates method handle objects for invoking methods (e.g., get methods and set methods) provided by the child mapper object.

One or more embodiments described in this Specification and/or recited in the claims may not be included in this General Overview section.

### 2. Architectural Overview

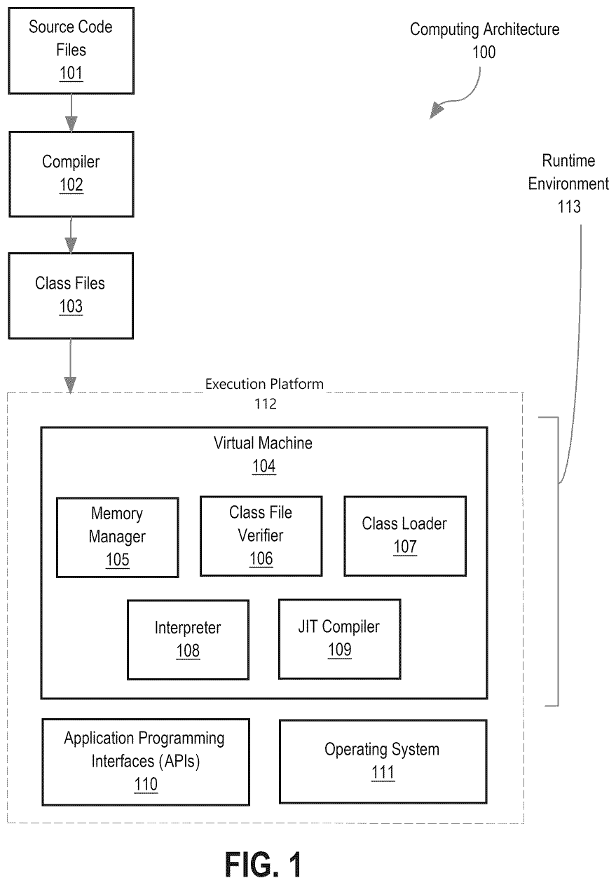

FIG. 1 illustrates an example architecture in which techniques described herein may be practiced. Software and/or hardware components described with relation to the example architecture may be omitted or associated with a different set of functionality than described herein. Software and/or hardware components, not described herein, may be used within an environment in accordance with one or more embodiments. Accordingly, the example environment should not be constructed as limiting the scope of any of the claims.

As illustrated in FIG. 1, a computing architecture 100 includes source code files 101 which are compiled by a compiler 102 into class files 103 representing the program to be executed. The class files 103 are then loaded and executed by an execution platform 112, which includes a runtime environment 113, an operating system 111, and one or more application programming interfaces (APIs) 110 that enable communication between the runtime environment 113 and the operating system 111. The runtime environment 113 includes a virtual machine 104 comprising various components, such as a memory manager 105 (which may include a garbage collector), a class file verifier 106 to check the validity of class files 103, a class loader 107 to locate and build in-memory representations of classes, an interpreter 108 for executing the virtual machine 104 code, and a just-in-time (JIT) compiler 109 for producing optimized machine-level code.

In an embodiment, the computing architecture 100 includes source code files 101 that contain code that has been written in a particular programming language, such as Java, C, C++, C#, Ruby, Perl, etc. Thus, the source code files 101 adhere to a particular set of syntactic and/or semantic rules for the associated language. For example, code written in Java adheres to the Java Language Specification. However, since specifications are updated and revised over time, the source code files 101 may be associated with a version number indicating the revision of the specification to which the source code files 101 adhere. The exact programming language used to write the source code files 101 is generally not critical.

In various embodiments, the compiler 102 converts the source code, which is written according to a specification directed to the convenience of the programmer, to either machine or object code, which is executable directly by the particular machine environment, or an intermediate representation (“virtual machine code/instructions”), such as bytecode, which is executable by a virtual machine 104 that is capable of running on top of a variety of particular machine environments. The virtual machine instructions are executable by the virtual machine 104 in a more direct and efficient manner than the source code. Converting source code to virtual machine instructions includes mapping source code functionality from the language to virtual machine functionality that utilizes underlying resources, such as data structures. Often, functionality that is presented in simple terms via source code by the programmer is converted into more complex steps that map more directly to the instruction set supported by the underlying hardware on which the virtual machine 104 resides.

In general, programs are executed either as a compiled or an interpreted program. When a program is compiled, the code is transformed globally from a first language to a second language before execution. Since the work of transforming the code is performed ahead of time; compiled code tends to have excellent run-time performance. In addition, since the transformation occurs globally before execution, the code can be analyzed and optimized using techniques such as constant folding, dead code elimination, inlining, etc. However, depending on the program being executed, the startup time can be significant. In addition, inserting new code would require the program to be taken offline, re-compiled, and re-executed. For many dynamic languages (such as Java) which are designed to allow code to be inserted during the program's execution, a purely compiled approach may be inappropriate. When a program is interpreted, the code of the program is read line-by-line and converted to machine-level instructions while the program is executing. As a result, the program has a short startup time (can begin executing almost immediately), but the run-time performance is diminished by performing the transformation at runtime. Furthermore, since various instructions are analyzed individually, many optimizations that rely on a more global analysis of the program cannot be performed.

In some embodiments, the virtual machine 104 includes an interpreter 108 and a JIT compiler 109 (or a component implementing aspects of both), and executes programs using a combination of interpreted and compiled techniques. For example, the virtual machine 104 may initially begin by interpreting the virtual machine instructions representing the program via the interpreter 108 while tracking statistics related to program behavior, such as how often different sections or blocks of code are executed by the virtual machine 104. Once a block of code surpasses a threshold (is “hot”), the virtual machine 104 invokes the JIT compiler 109 to perform an analysis of the block and generate optimized machine-level instructions which replaces the “hot” block of code for future executions. Since programs tend to spend most time executing a small portion of overall code, compiling just the “hot” portions of the program can provide similar performance to fully compiled code, but without the start-up penalty. Furthermore, although the optimization analysis is constrained to the “hot” block being replaced, there still exists far greater optimization potential than converting instructions individually. There are several variations on the above described example, such as tiered compiling.

In order to provide clear examples, the source code files 101 have been illustrated as the “top level” representation of the program to be executed by the execution platform 112. Although the computing architecture 100 depicts the source code files 101 as a “top level” program representation, in other embodiments the source code files 101 may be an intermediate representation received via a “higher level” compiler that processed code files in a different language into the language of the source code files 101. Some examples in the following disclosure assume that the source code files 101 adhere to a class-based object-oriented programming language. However, this is not a requirement to utilizing the features described herein.

In an embodiment, compiler 102 receives as input the source code files 101 and converts the source code files 101 into class files 103 that are in a format expected by the virtual machine 104. For example, in the context of the JVM, the Java Virtual Machine Specification defines a particular class file format to which the class files 103 are expected to adhere. In some embodiments, the class files 103 contain the virtual machine instructions that have been converted from the source code files 101. However, in other embodiments, the class files 103 may contain other structures as well, such as tables identifying constant values and/or metadata related to various structures (classes, fields, methods, etc.).

The following discussion assumes that the class files 103 represents a respective “class” defined in the source code files 101 (or dynamically generated by the compiler 102/virtual machine 104). However, the aforementioned assumption is not a strict requirement and will depend on the implementation of the virtual machine 104. Thus, the techniques described herein may still be performed regardless of the exact format of the class files 103. In some embodiments, the class files 103 are divided into one or more “libraries” or “packages”, each of which includes a collection of classes that provide related functionality. For example, a library may contain one or more class files that implement input/output (I/O) operations, mathematics tools, cryptographic techniques, graphics utilities, etc. Further, some classes (or fields/methods within those classes) may include access restrictions that limit their use to within a particular class/library/package or to classes with appropriate permissions.

### 2.1 Example Class File Structure

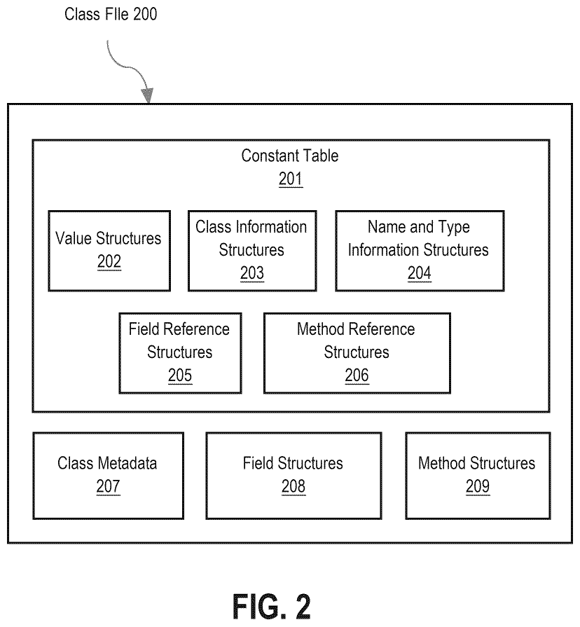

FIG. 2 illustrates an example structure for a class file 200 in block diagram form according to an embodiment. In order to provide clear examples, the remainder of the disclosure assumes that the class files 103 of the computing architecture 100 adhere to the structure of the example class file 200 described in this section. However, in a practical environment, the structure of the class file 200 will be dependent on the implementation of the virtual machine 104. Further, one or more features discussed herein may modify the structure of the class file 200 to, for example, add additional structure types. Therefore, the exact structure of the class file 200 is not critical to the techniques described herein. For the purposes of Section 2.1, “the class” or “the present class” refers to the class represented by the class file 200.

In FIG. 2, the class file 200 includes a constant table 201, class metadata 207, field structures 208, and method structures 209. In an embodiment, the constant table 201 is a data structure which, among other functions, acts as a symbol table for the class. For example, the constant table 201 may store data related to the various identifiers used in the source code files 101 such as type, scope, contents, and/or location. The constant table 201 has entries for value structures 202 (representing constant values of type int, long, double, float, byte, string, etc.), class information structures 203, name and type information structures 204, field reference structures 205, and method reference structures 206 derived from the source code files 101 by the compiler 102. In an embodiment, the constant table 201 is implemented as an array that maps an index i to structure j. However, the exact implementation of the constant table 201 is not critical.

In some embodiments, the entries of the constant table 201 include structures which index other constant table 201 entries. For example, an entry for one of the value structures 202 representing a string may hold a tag identifying its “type” as string and an index to one or more other value structures 202 of the constant table 201 storing char, byte or int values representing the ASCII characters of the string.

In an embodiment, field reference structures 205 of the constant table 201 hold an index into the constant table 201 to one of the class information structures 203 representing the class defining the field and an index into the constant table 201 to one of the name and type information structures 204 that provides the name and descriptor of the field. Method reference structures 206 of the constant table 201 hold an index into the constant table 201 to one of the class information structures 203 representing the class defining the method and an index into the constant table 201 to one of the name and type information structures 204 that provides the name and descriptor for the method. The class information structures 203 hold an index into the constant table 201 to one of the value structures 202 holding the name of the associated class.

The name and type information structures 204 hold an index into the constant table 201 to one of the value structures 202 storing the name of the field/method and an index into the constant table 201 to one of the value structures 202 storing the descriptor.

In an embodiment, class metadata 207 includes metadata for the class, such as version number(s), number of entries in the constant pool, number of fields, number of methods, access flags (if the class is public, private, final, abstract, etc.), an index to one of the class information structures 203 of the constant table 201 that identifies the present class, an index to one of the class information structures 203 of the constant table 201 that identifies the superclass (if any), etc.

In an embodiment, the field structures 208 represent a set of structures that identifies the various fields of the class. The field structures 208 store, for a field of the class, accessor flags for the field (if the field is static, public, private, final, etc.), an index into the constant table 201 to one of the value structures 202 that holds the name of the field, and an index into the constant table 201 to one of the value structures 202 that holds a descriptor of the field.

In an embodiment, the method structures 209 represent a set of structures that identifies the various methods of the class. The method structures 209 store, for a method of the class, accessor flags for the method (e.g. if the method is static, public, private, synchronized, etc.), an index into the constant table 201 to one of the value structures 202 that holds the name of the method, an index into the constant table 201 to one of the value structures 202 that holds the descriptor of the method, and the virtual machine instructions that correspond to the body of the method as defined in the source code files 101.

In an embodiment, a descriptor represents a type of a field or method. For example, the descriptor may be implemented as a string adhering to a particular syntax. While the exact syntax is not critical, a few examples are described below.

In an example where the descriptor represents a type of the field, the descriptor identifies the type of data held by the field. In an embodiment, a field can hold a basic type, an object, or an array. When a field holds a basic type, the descriptor is a string that identifies the basic type (e.g., “B”=byte, “C”=char, “D”=double, “F”=float, “I”=int, “J”=long int, etc.). When a field holds an object, the descriptor is a string that identifies the class name of the object (e.g., “L ClassName”). “L” in this case indicates a reference, thus “L ClassName” represents a reference to an object of class ClassName. When the field is an array, the descriptor identifies the type held by the array. For example, “[B” indicates an array of bytes, with “[” indicating an array and “B” indicating that the array holds the basic type of byte. However, since arrays can be nested, the descriptor for an array may also indicate the nesting. For example, “[[L ClassName” indicates an array where an index holds an array that holds objects of class ClassName. In some embodiments, the ClassName is fully qualified and includes the simple name of the class, as well as the pathname of the class. For example, the ClassName may indicate where the file is stored in the package, library, or file system hosting the class file 200.

In the case of a method, the descriptor identifies the parameters of the method and the return type of the method. For example, a method descriptor may follow the general form “({ParameterDescriptor}) ReturnDescriptor”, where the {ParameterDescriptor} is a list of field descriptors representing the parameters and the ReturnDescriptor is a field descriptor identifying the return type. For instance, the string “V” may be used to represent the void return type. Thus, a method defined in the source code files 101 as “Object m(int I, double d, Thread t) { . . . }” matches the descriptor “(I D L Thread) L Object”.

In an embodiment, the virtual machine instructions held in the method structures 209 include operations which reference entries of the constant table 201. Using Java as an example, consider the following class:

```
class A
{
    int add12and13( ) {
    return B.addTwo(12, 13);
}
    }
```

In the above example, the Java method add12and13 is defined in class A, takes no parameters, and returns an integer. The body of method add12and13 calls static method addTwo of class B that takes the constant integer values 12 and 13 as parameters and returns the result. Thus, in the constant table 201, the compiler 102 includes, among other entries, a method reference structure that corresponds to the call to the method B.addTwo. In Java, a call to a method compiles down to an invoke command in the bytecode of the JVM (in this case invokestatic as addTwo is a static method of class B). The invoke command is provided an index into the constant table 201 corresponding to the method reference structure that identifies the class defining addTwo “B”, the name of addTwo “addTwo”, and the descriptor of addTwo “(I I)I”. For example, assuming the aforementioned method reference is stored at index 4, the bytecode instruction may appear as “invokestatic #4”.

Since the constant table 201 refers to classes, methods, and fields symbolically with structures carrying identifying information, rather than direct references to a memory location, the entries of the constant table 201 are referred to as “symbolic references”. One reason that symbolic references are utilized for the class files 103 is because, in some embodiments, the compiler 102 is unaware of how and where the classes will be stored once loaded into the runtime environment 113. As will be described in Section 2.3, eventually the run-time representations of the symbolic references are resolved into actual memory addresses by the virtual machine 104 after the referenced classes (and associated structures) have been loaded into the runtime environment and allocated concrete memory locations.

### 2.2 Example Virtual Machine Architecture

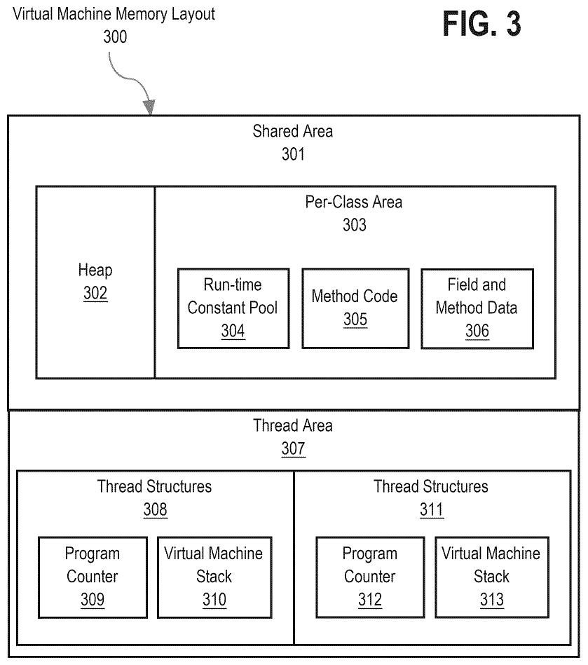

FIG. 3 illustrates an example virtual machine memory layout 300 in block diagram form according to an embodiment. In order to provide clear examples, the remaining discussion will assume that the virtual machine 104 adheres to the virtual machine memory layout 300 depicted in FIG. 3. In addition, although components of the virtual machine memory layout 300 may be referred to as memory “areas”, there is no requirement that the memory areas are contiguous.

In the example illustrated by FIG. 3, the virtual machine memory layout 300 is divided into a shared area 301 and a thread area 307. The shared area 301 represents an area in memory where structures shared among the various threads executing on the virtual machine 104 are stored. The shared area 301 includes a heap 302 and a per-class area 303. In an embodiment, the heap 302 represents the run-time data area from which memory for class instances and arrays is allocated. In an embodiment, the per-class area 303 represents the memory area where the data pertaining to the individual classes are stored. In an embodiment, the per-class area 303 includes, for a loaded class, a run-time constant pool 304 representing data from the constant table 201 of the class, field and method data 306 (for example, to hold the static fields of the class), and the method code 305 representing the virtual machine instructions for methods of the class.

The thread area 307 represents a memory area where structures specific to individual threads are stored. In FIG. 3, the thread area 307 includes thread structures 308 and thread structures 311, representing the per-thread structures utilized by different threads. In order to provide clear examples, the thread area 307 depicted in FIG. 3 assumes two threads are executing on the virtual machine 104. However, in a practical environment, the virtual machine 104 may execute any arbitrary number of threads, with the number of thread structures scaled accordingly.

In an embodiment, thread structures 308 includes program counter 309 and virtual machine stack 310. Similarly, thread structures 311 includes program counter 312 and virtual machine stack 313. In an embodiment, program counter 309 and program counter 312 store the current address of the virtual machine instruction being executed by their respective threads.

Thus, as a thread steps through the instructions, the program counters are updated to maintain an index to the current instruction. In an embodiment, virtual machine stack 310 and virtual machine stack 313 store frames for their respective threads that hold local variables and partial results, and is also used for method invocation and return.

In an embodiment, a frame is a data structure used to store data and partial results, return values for methods, and perform dynamic linking. A new frame is created each time a method is invoked. A frame is destroyed when the method that caused the frame to be generated completes. Thus, when a thread performs a method invocation, the virtual machine 104 generates a new frame and pushes that frame onto the virtual machine stack associated with the thread.

When the method invocation completes, the virtual machine 104 passes back the result of the method invocation to the previous frame and pops the current frame off of the stack. In an embodiment, for a given thread, one frame is active at any point. This active frame is referred to as the current frame, the method that caused generation of the current frame is referred to as the current method, and the class to which the current method belongs is referred to as the current class.

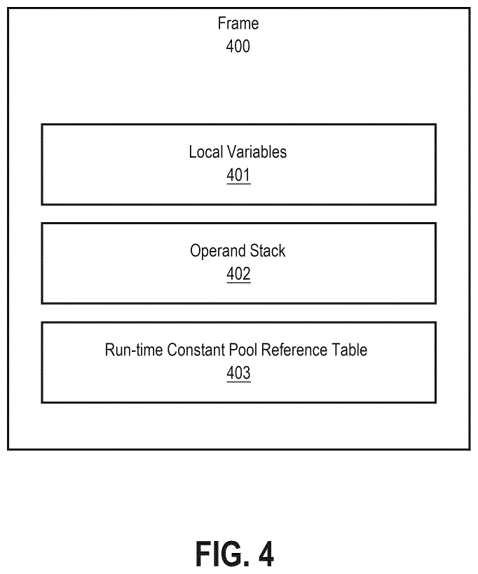

FIG. 4 illustrates an example frame 400 in block diagram form according to an embodiment. In order to provide clear examples, the remaining discussion will assume that frames of virtual machine stack 310 and virtual machine stack 313 adhere to the structure of frame 400.

In an embodiment, frame 400 includes local variables 401, operand stack 402, and run-time constant pool reference table 403. In an embodiment, the local variables 401 are represented as an array of variables that each hold a value, for example, Boolean, byte, char, short, int, float, or reference. Further, some value types, such as longs or doubles, may be represented by more than one entry in the array. The local variables 401 are used to pass parameters on method invocations and store partial results. For example, when generating the frame 400 in response to invoking a method, the parameters may be stored in predefined positions within the local variables 401, such as indexes 1-N corresponding to the first to Nth parameters in the invocation.

In an embodiment, when the frame 400 is created by the virtual machine 104, the operand stack 402 is empty by default. The virtual machine 104 then supplies instructions from the method code 305 of the current method to load constants or values from the local variables 401 onto the operand stack 402. Other instructions take operands from the operand stack 402, operate on them, and push the result back onto the operand stack 402. Furthermore, the operand stack 402 is used to prepare parameters to be passed to methods and to receive method results. For example, the parameters of the method being invoked could be pushed onto the operand stack 402 prior to issuing the invocation to the method. The virtual machine 104 then generates a new frame for the method invocation where the operands on the operand stack 402 of the previous frame are popped and loaded into the local variables 401 of the new frame. When the invoked method terminates, the new frame is popped from the virtual machine stack and the return value is pushed onto the operand stack 402 of the previous frame.

In an embodiment, the run-time constant pool reference table 403 contains a reference to the run-time constant pool 304 of the current class. The run-time constant pool reference table 403 is used to support resolution. Resolution is the process whereby symbolic references in the constant pool 304 are translated into concrete memory addresses, loading classes as necessary to resolve as-yet-undefined symbols and translating variable accesses into appropriate offsets into storage structures associated with the run-time location of these variables.

### 2.3 Loading, Linking, and Initializing

In an embodiment, the virtual machine 104 dynamically loads, links, and initializes classes. Loading is the process of finding a class with a particular name and creating a representation from the associated class file 200 of that class within the memory of the runtime environment 113. For example, creating the representation from the associated class file 200 may include creating the run-time constant pool 304, method code 305, and field and method data 306 for the class within the per-class area 303 of the virtual machine memory layout 300. Linking is the process of taking the in-memory representation of the class and combining it with the run-time state of the virtual machine 104 so that the methods of the class can be executed. Initialization is the process of executing the class constructors to set the starting state of the field and method data 306 of the class and/or create class instances on the heap 302 for the initialized class.

The following are examples of loading, linking, and initializing techniques that may be implemented by the virtual machine 104. However, in many embodiments the steps may be interleaved, such that an initial class is loaded, then during linking a second class is loaded to resolve a symbolic reference found in the first class, which in turn causes a third class to be loaded, etc. Thus, progress through the stages of loading, linking, and initializing can differ from class to class. Furthermore, some embodiments may delay (perform “lazily”) one or more functions of the loading, linking, and initializing process until the class is required. For example, resolution of a method reference may be delayed until a virtual machine instruction invoking the method is executed. Thus, the exact timing of when the steps are performed for each class can vary greatly between implementations.

To begin the loading process, the virtual machine 104 invokes the class loader 107 which loads an initial class. The technique by which the initial class is specified will vary from embodiment to embodiment. For example, one technique may have the virtual machine 104 accept a command line argument on startup that specifies the initial class.

To load a class, the class loader 107 parses the class file 200 corresponding to the class and determines if the class file 200 is well-formed (meets the syntactic expectations of the virtual machine 104). If not, the class loader 107 generates an error. For example, in Java the error might be generated in the form of an exception which is thrown to an exception handler for processing. Otherwise, the class loader 107 generates the in-memory representation of the class by allocating the run-time constant pool 304, method code 305, and field and method data 306 for the class within the per-class area 303.

In some embodiments, when the class loader 107 loads a class, the class loader 107 also recursively loads the super-classes of the loaded class. For example, the virtual machine 104 may ensure that the super-classes of a particular class are loaded, linked, and/or initialized before proceeding with the loading, linking and initializing process for the particular class.

During linking, the virtual machine 104 verifies the class, prepares the class, and resolves the symbolic references defined in the run-time constant pool 304 of the class.

To verify the class, the virtual machine 104 checks if the in-memory representation of the class is structurally correct. For example, the virtual machine 104 may check that each class except the generic class Object has a superclass, check that final classes have no sub-classes and final methods are not overridden, check if constant pool entries are consistent with one another, check if the current class has correct access permissions for classes/fields/structures referenced in the constant pool 304, check that the virtual machine 104 code of methods will not cause unexpected behavior (e.g. making sure a jump instruction does not send the virtual machine 104 beyond the end of the method), etc. The exact checks performed during verification are dependent on the implementation of the virtual machine 104. In some cases, verification may cause additional classes to be loaded, but does not necessarily require those classes to also be linked before proceeding. For example, assume Class A contains a reference to a static field of Class B. During verification, the virtual machine 104 may check Class B to ensure that the referenced static field actually exists, which might cause loading of Class B, but not necessarily the linking or initializing of Class B. However, in some embodiments, certain verification checks can be delayed until a later phase, such as being checked during resolution of the symbolic references. For example, some embodiments may delay checking the access permissions for symbolic references until those references are being resolved.

To prepare a class, the virtual machine 104 initializes static fields located within the field and method data 306 for the class to default values. In some cases, setting the static fields to default values may not be the same as running a constructor for the class. For example, the verification process may zero out or set the static fields to values that the constructor would expect those fields to have during initialization.

During resolution, the virtual machine 104 dynamically determines concrete memory address from the symbolic references included in the run-time constant pool 304 of the class. To resolve the symbolic references, the virtual machine 104 utilizes the class loader 107 to load the class identified in the symbolic reference (if not already loaded). Once loaded, the virtual machine 104 has knowledge of the memory location within the per-class area 303 of the referenced class and its fields/methods. The virtual machine 104 then replaces the symbolic references with a reference to the concrete memory location of the referenced class, field, or method. In an embodiment, the virtual machine 104 caches resolutions to be reused in case the same class/name/descriptor is encountered when the virtual machine 104 processes another class. For example, in some cases, class A and class B may invoke the same method of class C. Thus, when resolution is performed for class A, that result can be cached and reused during resolution of the same symbolic reference in class B to reduce overhead.

In some embodiments, the step of resolving the symbolic references during linking is optional. For example, an embodiment may perform the symbolic resolution in a “lazy” fashion, delaying the step of resolution until a virtual machine instruction that requires the referenced class/method/field is executed.

During initialization, the virtual machine 104 executes the constructor of the class to set the starting state of that class. For example, initialization may initialize the field and method data 306 for the class and generate/initialize any class instances on the heap 302 created by the constructor. For example, the class file 200 for a class may specify that a particular method is a constructor that is used for setting up the starting state. Thus, during initialization, the virtual machine 104 executes the instructions of that constructor.

In some embodiments, the virtual machine 104 performs resolution on field and method references by initially checking if the field/method is defined in the referenced class. Otherwise, the virtual machine 104 recursively searches through the super-classes of the referenced class for the referenced field/method until the field/method is located, or the top-level superclass is reached, in which case an error is generated.

### 3. Memory Projection System

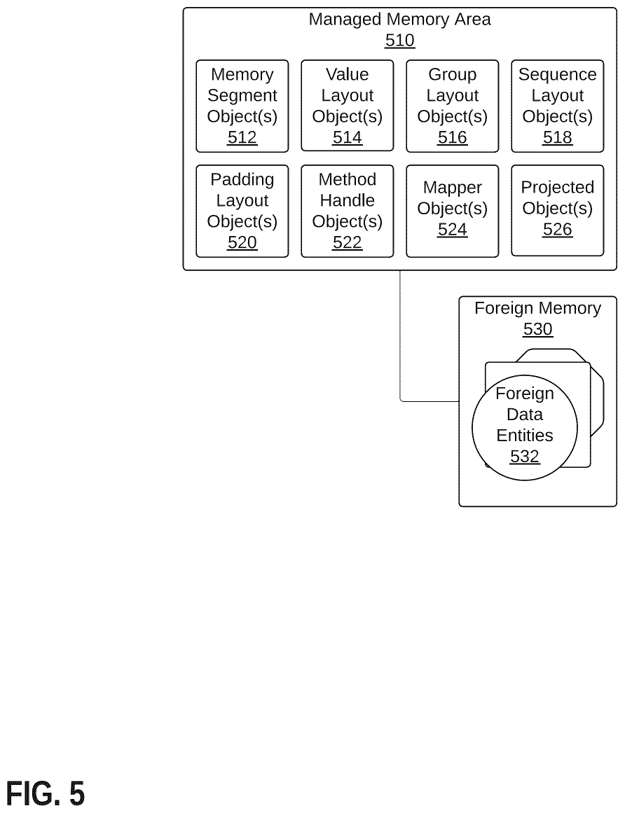

FIG. 5 illustrates a system 500 in accordance with one or more embodiments. As illustrated in FIG. 5, system 500 includes managed memory area 510 and foreign memory 530. In one or more embodiments, the system 500 may include more or fewer components than the components illustrated in FIG. 5. The components illustrated in FIG. 5 may be local to or remote from each other. The components illustrated in FIG. 5 may be implemented in software and/or hardware. Each component may be distributed over multiple applications and/or machines. Multiple components may be combined into one application and/or machine. Operations described with respect to one component may instead be performed by another component.

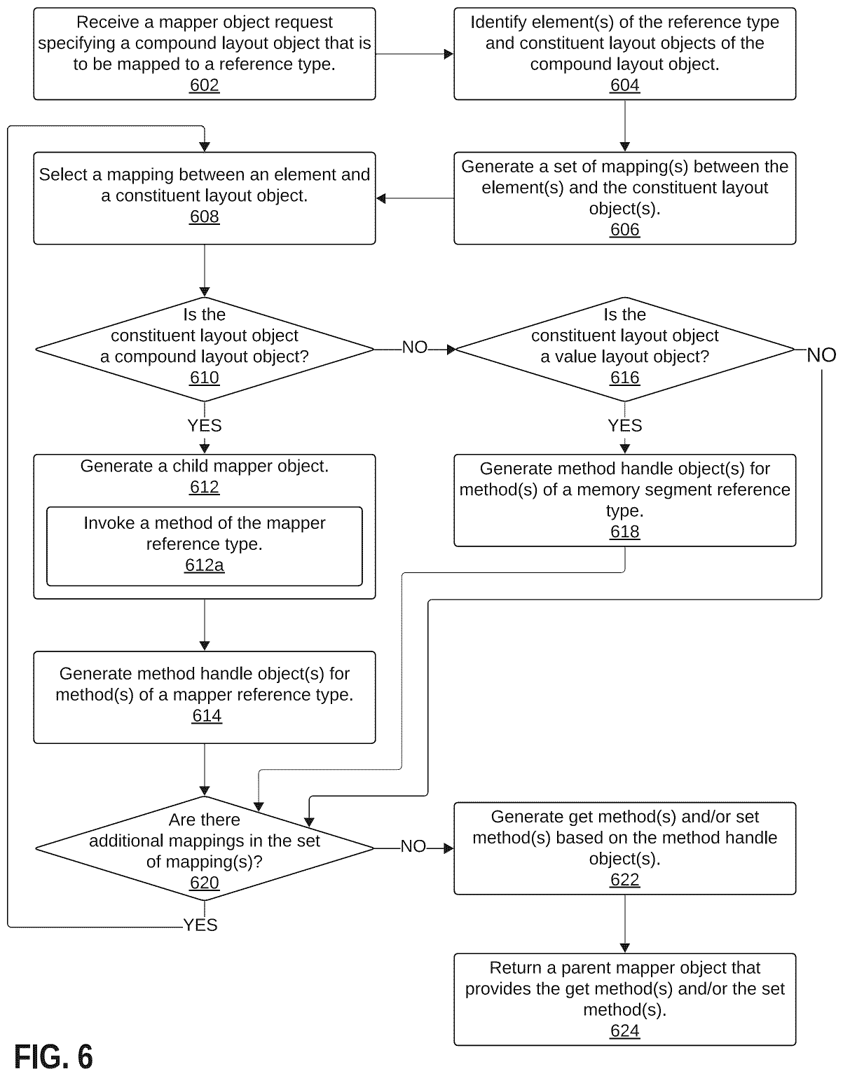

In an embodiment, system 500 refers to hardware and/or software configured to perform operations described herein for mapping a region of memory to an abstraction. Examples of operations for mapping a region of memory to an abstraction are described below with reference to FIG. 6.

In an embodiment, system 500 is implemented in the context of one or more class-based, object-oriented programming languages. Examples of class-based, object-oriented programming languages include Java, C++, C#, Python, Ruby, and others. This implementation of system 500 in the context of class-based, object-oriented program language(s) is described herein for illustrative purposes and is not intended to define any limits to the disclosure. The techniques described herein are equally applicable to other contexts and other programming languages.

In an embodiment, managed memory area 510 is a data repository allocated for runtime memory. Managed memory area 510 is any type of storage unit and/or device (e.g., a file system, database, collection of tables, or any other storage mechanism) for storing data. Managed memory 510 may include multiple different storage units and/or devices. If managed memory area 510 does include multiple different storage units and/or devices, the multiple different storage units and/or devices may or may not be of the same type or located at the same physical site. Managed memory area 510 may be implemented or executed on the same computing system as foreign memory 530. Additionally, or alternatively, managed memory area 510 may be implemented or executed on a computing system that is separate from foreign memory 530. Managed memory area 510 may be communicatively coupled to other components of system 500 (those illustrated in FIG. 5 or otherwise) via a direct connection and/or via a network. As illustrated in FIG. 5, managed memory area 510 includes memory segment object(s) 512, value layout object(s) 514, group layout object(s) 516, sequence layout object(s) 518, padding layout object(s) 520, method handle object(s) 522, mapper object(s) 524, and projected object(s) 526. Information describing memory segment object(s) 512, value layout object(s) 514, group layout object(s) 516, sequence layout object(s) 518, padding layout object(s) 520, method handle object(s) 522, mapper object(s) 524, and projected object(s) 526 may be implemented across any of the components within the system 500 (those illustrated in FIG. 5 or otherwise). However, this information is illustrated within managed memory area 510 for purposes of clarity and explanation.

In an embodiment, managed memory area 510 stores runtime objects associated with one or more currently executing program instances. In particular, managed memory area 510 stores runtime objects that are created by the program thread(s) while executing the program instance(s). Managed memory area 510 is managed by a garbage collector that reclaims memory allocated to runtime objects that are no longer needed by a program instance. Managed memory area 510 may be implemented in volatile memory of a computing system (e.g., main memory), or managed memory area 510 may be implemented elsewhere. In the example context of FIG. 3, managed memory area 510 is implemented as heap 302.

In an embodiment, a memory segment object 512 is a runtime object that serves as an abstraction of a region of memory. A region of memory abstracted by a runtime object 512 may be any portion of memory space. An example region of memory is a group of contiguous bits. A memory segment object 512 that is an abstraction of a region of memory is said to be “backed by” the region of memory. Note that a memory segment object 512 that is backed by a region of memory typically does not reside within that region of memory. A memory segment object 512 is backed by a region of managed memory area 510, or the memory segment object 512 is backed by a region of memory outside of managed memory area 510 (e.g., a region of foreign memory 530). As used herein, the term “domestic memory segment object” refers to a memory segment object 512 that is backed by a region of managed memory area 510, and the term “foreign memory segment object” refers to a memory segment object 512 that is backed by a region of memory outside of managed memory area 510. Note that both domestic memory segment objects 512 and foreign memory segment objects 512 reside in managed memory area 510. A memory segment object 512 indicates an address of a region of memory, a size of the region of memory (e.g., expressed as a number of contiguous bytes), and/or other information. In an example, the address of a domestic memory segment object 512 indicates an offset value, and the address of a foreign memory segment object 512 identifies a physical location within memory.

In an embodiment, a memory segment object 512 provides methods of a memory segment reference type that can be used to perform low-level operations on a region of memory backing the memory segment object 512. In general, methods provided by a memory segment object 512 cannot be used to perform operations outside of the boundaries that are demarcated by the memory segment object's 512 specified address and size. In other words, the methods provided by a memory segment object 512 generally cannot be used to interact with memory that resides outside of the region of memory that backs the memory segment object 512. An example memory segment object 512 provides get methods, set methods, and other methods. An example get method of a memory segment object 512 performs a read operation on a region of memory backing the example memory segment object 512. The example get method accepts a memory layout object as one parameter, and the example get method accepts a positional value as another parameter. Example positional values include an offset value, an index value, and others. An example set method of a memory segment object 512 performs a write operation on a region of memory backing the memory segment object 512. Like the example get method, the example set method accepts a memory layout object as one parameter, and the example set method accepts a positional value as another parameter. Note that a memory segment object 512 may provide multiple get methods, and the memory segment object 512 may provide multiple set methods. A memory segment object 512 may be created by invoking a method (e.g., a factory method, a constructor method, etc.) of a memory segment reference type. In an example, a memory segment reference type is a memory segment interface, and a memory segment object 512 may be created by invoking a static factory method of the memory segment interface. In other examples, a memory segment interface is substituted for another variety of reference type such as a class.

In an embodiment, a memory layout object is a runtime object that describes the contents of region(s) of memory. A memory layout object generally indicates a size of a region of memory, an alignment of a region of memory, and/or other information. An example memory layout object specifies a size and an alignment in units of bytes. A memory layout object may be used to describe the contents of a single region of memory, or a memory layout object may be used to describe multiple regions of memory that share the characteristics specified by the memory layout object (e.g., a size, an alignment, and/or other characteristics). In general, memory layout objects are used to describe the contents of regions of memory backing memory segment objects 512; accordingly, a memory layout object may be said to describe the contents of a memory segment object 512. A memory layout object may describe a domestic memory segment object 512, and/or the memory layout object may describe a foreign memory segment object 512. Example memory layout objects include a value layout object 514, a group layout object 516, a sequence layout object 518, a padding layout object 520, and others. A memory layout object is created by invoking a method of a memory layout reference type, or the memory layout object is created by invoking a method of another reference type (e.g., a reference type that directly or indirectly extends the memory layout reference type, a reference type that directly or indirectly implements the memory layout reference type, etc.). In an example, a memory layout reference type is a memory layout interface. In this example, the memory layout interface is extended by multiple subinterfaces, such as a value layout interface, a group layout interface, a padding layout interface, a sequence layout interface, and/or other reference types. Furthermore, in this example, a memory layout object is created by invoking a static factory method of the memory layout interface, or the memory layout object is created by invoking another method of another reference type (e.g., a factory method defined by a subinterface). In other examples, the memory layout interface is substituted for another variety of reference type such as a class.

In an embodiment, a value layout object 514 is a memory layout object that describes the contents of regions(s) of memory that store basic value(s). Example basic values include an address, a primitive value (e.g., a Boolean, a byte, a char, a double, a float, an int, a long, a short, etc.), and others. A value layout object 514 generally indicates a size, an alignment, a byte order, a carrier, and/or other information. A byte order of a value layout object 514 specifies the arrangement of bytes in a region of memory. Example byte orders include big endian, little endian, middle endian, and others. The carrier of a value layout object 514 is the type that should be used when accessing a region of memory using the value layout object 514. Example carriers include a Boolean class, a byte class, a char class, a double class, a float class, an int class, a memory segment class, and other types. In an example, a value layout object 514 is created by invoking a method declared by (a) a value layout interface, (b) a nested interface of the value layout interface, (c) a subinterface of the value layout interface, or (d) another reference type. In other examples the value layout interface is substituted for another variety of reference type such as a class.

In an embodiment, a compound layout object describes a region of memory that is modeled by multiple constituent layout objects. A compound layout object often describes a region of memory storing composite data. Example compound layout objects include a group layout object 516, a sequence layout object 518, and others. Example constituent layout objects include a member layout object, an element layout object, and others. Note that a runtime object may simultaneously be (a) a constituent layout object and (b) a compound layout object. Recall that a constituent layout object that is a compound layout object is referred to herein as an “inner compound layout object.”

In an embodiment, a group layout object 516 is a compound layout object that is an aggregation of multiple member layout objects. A group layout object 516 describes the contents of a single region of memory, or the group layout object 516 describes the contents of multiple regions of memory. A group layout object 516 generally indicates a size, an alignment, a list of member layout objects, and/or other information. A member layout object of a group layout object 516 is a value layout object 514, another group layout object 516, a sequence layout object 518, a padding layout object 520, or another variety of memory layout object. Note that a member layout object that is a group layout object 516 (referred to herein as an “inner group layout object”) will, in turn, possess another set of member layout objects. A group layout object 516 is a struct layout object, a union layout object, or another variety of group layout object 516. A struct layout object is a group layout object 516 having member layout objects that are arranged sequentially at separate starting addresses. In contrast, a union layout object is a group layout object 516 having member layout objects that are laid out at the same starting address. In an example, a group layout object 516 is created by invoking a method (e.g., a factory method) declared by (a) a memory layout interface, (b) a group layout interface, or (c) another reference type. In this example, the memory layout interface is extended by the group layout interface, and the group layout interface is extended by multiple other subinterfaces, such as a struct layout interface and a union layout interface. In other examples, the group layout interface is substituted for another variety of reference type such as a class.

In an embodiment, a sequence layout object 518 is a compound memory layout object that is made up of homogenous repetitions of a single element layout object. A sequence layout object 518 is used to describe a single region of memory, or the sequence layout object 518 is used to describe multiple regions of memory. A sequence layout object 518 generally indicates a size, an alignment, an element layout object, an element count, and/or other information. An element count of a sequence layout object 518 indicates an element layout object's number of repetitions within the sequence layout object 518. In an example, a sequence layout object 518 is created by invoking a method declared by the (a) a memory layout interface, (b) a sequence layout interface, or (c) another reference type. In this example, the memory layout interface is extended by the sequence layout interface. In other examples, the sequence layout interface is substituted for another variety of reference type such as a class.

In an embodiment, a padding layout object 520 is a runtime object that describes a region of memory that stores padding. A padding layout object 520 generally specifies a size of extra space that that is not typically accessed by program instances (e.g., extra space that is used for aligning member layout objects of a group layout object 516 around world boundaries). In an example, a padding layout object 520 is created by invoking a method declared by (a) a memory layout interface, (b) a padding layout interface, or (c) another reference type. In this example, the memory layout interface is extended by the padding layout interface. In other examples, the padding layout interface is substituted for another variety of reference type such as a class.

In an embodiment, a method handle object 522 is a strongly typed, directly executable reference to an underlying method, constructor, field, or similar low-level operation, with optional transformations of arguments or return values. A method handle object 522 possesses invoker method(s) that provide direct access to the method handle object's underlying method, constructor, field, or other low-level operations. A method handle object 522 may be used to invoke a method of a reference type, such as a memory segment reference type, a mapper reference type, or another reference type. A method handle object 522 that refers to a get method (e.g., a get method of a memory segment reference type, a get method of a mapper reference type, etc.) is referred to herein as a “get method handle object.” Similarly, a method handle object 522 that refers to a set method (e.g., a set method of a memory segment reference type, a set method of a mapper reference type, etc.) is referred to herein as a “set method handle object.” Note that a method handle object 522 to a method may specify arguments for invoking the method. For example, a method handle object 522 to a method may specify input parameters for invoking the method, and/or the method handle object may specify a receiver for the method (e.g., a runtime object that the method is to be invoked on). In an example, a method handle object 522 is an instance of a method handle class. In this example, a method handle object 522 can be created by invoking a method of a method handles class. Note that the method handle class and the method handles class are two separate classes in this example. In other examples, the method handle class and/or the method handles class are substituted for another variety of reference type such as an interface. It should also be noted that a method handle object 522 may be substituted for or used in combination with other similar abstractions such as function pointers.

In an embodiment, a mapper object 524 is a runtime object that represents a mapping between a reference type and a memory layout object. For example, a mapper object 524 may represent a mapping between (a) a record class, a standard class, or an interface and (b) a group layout object 516. A mapper object 524 provides methods declared by a mapper reference type and/or methods declared elsewhere. In particular, a mapper object 524 provides method(s) for projecting information between (a) runtime objects associated with a reference type (e.g., instances of the reference type, implementation objects of the reference type, etc.) and (b) regions of memory described by a memory layout object. A mapper object 524 generally provides get method(s), set method(s), and/or other methods. An example get method of a mapper object 524 (a) retrieves information from a region of memory (e.g., a region of managed memory area 510, a region of foreign memory 530, etc.) that is organized according to a memory layout object and (b) generates a runtime object associated with a reference type to represent that information in managed memory area 510. An example set method of a mapper object 524 (a) extracts information represented by a runtime object of a reference type and (b) writes the extracted information to a region of memory (e.g., a region of managed memory area 510, a region of foreign memory 530, etc.) in accordance with characteristics defined by a memory layout object. A memory segment object 512 that is backed by a region of memory storing information that is being extracted by a method of a mapper object 524 (e.g., a get method or a set method) is referred to herein as a “source memory segment object.” A source memory segment object 512 is a domestic memory segment object 512, or the source memory segment object 512 is a foreign memory segment object 512. A memory segment object 512 that is backed by a region of memory that is being written to by a method of a mapper object 524 is referred to herein as a “target memory segment object.” A target memory segment object 512 is a domestic memory segment object 512, or the target memory segment object 512 is a foreign memory segment object 512.

In an embodiment, a mapper object 524 is related to a mapper reference type. A mapper object 524 may be created by invoking a method (e.g., a factory method, a constructor method, etc.) of a mapper reference type or another reference type that is related to the mapper reference type (e.g., a direct or indirect subclass, subinterface, implementation class, etc.). A method for creating a mapper object 524 (e.g., a factory method, a constructor method, etc.) may accept one or more input parameters. Example input parameters to a method for creating a mapper object 524 include a reference type, a memory layout object, and/or other information. In an example, a method for creating a mapper object 524 accepts a reference type as one parameter, and the method accepts a memory layout object that is to be mapped to the reference type as another parameter. Note that an invocation of a method for creating a mapper object need not specify a reference type and/or a memory layout object that is to be mapped to the reference type. Instead, a reference type and/or a memory layout object that is to be mapped to the reference type by the mapper object may be inferred by the system 500. In another example, a method for creating a mapper object 524 may be successfully invoked while specifying as an input parameter only one of (a) a reference type or (b) a memory layout object. If an invocation of the method in this example specifies (a) a reference type but not a memory layout object, the method may infer the memory layout object that is to be mapped to the reference type. Conversely, if an invocation of the method in this example specifies a memory layout object but not a reference type, the method may infer the reference type that is to be mapped to the memory layout object. It should also be noted that a method of the mapper reference type may infer an element of a reference type or a constituent layout object of a compound layout object.

In an embodiment, a mapper object 524 is created by invoking a static factory method of a segment mapper interface. The segment mapper interface provides methods for generating mapper objects 524 that map classes to compound layout objects (e.g., an “ofRecord” method), methods for generating mapper objects 524 that map interfaces to compound layout objects (e.g., an “ofInterface” method), and/or methods for generating other mapper objects 524. In an example, an “ofRecord” method of the segment mapper interface may accept, as an input parameter, at least one of (a) a record class and/or (b) a group layout object. If an “ofRecord” method is successfully invoked in this example, the “ofRecord” method returns a segment mapper object (i.e., a mapper object 524) that maps a record class to a group layout object, and calling a get method of the segment mapper object may return an instance of the record class (i.e., a record instance). In an example, an “ofInterface” method of the segment mapper interface may accept, as an input parameter, at least one of (a) an interface and/or (b) a group layout object. If an “ofInterface” method is successfully invoked in this example, the “ofInterface” method returns a segment mapper object (i.e., a mapper object 524) that maps an interface to a group layout object, and calling a get method of the segment mapper object may return an instance of a class that directly or indirectly implements the interface. An instance of a class that directly or indirectly implements an interface is referred to herein as an “interface object.”

In an embodiment, a mapper object 524 is embedded into a memory layout object such as a compound layout object. For example, a mapper object 524 may be embedded into a group layout object 516. In other words, the mapper object 524 of this example is a group layout object 516 that is internally bound to a specific high-level representation (e.g., a record class, an interface, or another reference type). If a memory layout object embeds a mapper object 524, the memory layout object embeds a single mapper object 524, or the memory layout object embeds multiple mapper objects 524. A memory layout object embedding a mapper object 524 may be characterized by a carrier type. In addition to embedding mapper object(s) 524, a memory layout object may hold method handle object(s) 522. Note that method handle objects 522 that are held by a memory layout object can be used to call get methods of memory segment objects 512, set methods of memory segment objects 512, get methods of mapper objects 524, set methods of mapper objects 524, and/or other methods. It should also be noted that embedding mapper objects 524 within memory layout objects may improve integration of mapper objects 524 with API points that receive memory layout objects. For example, recall that methods of a memory segment object 512 (e.g., a get method, a set method, etc.) may accept a memory layout object as an input parameter. These methods can be called on a memory segment object 512 while specifying a memory layout object embedding a mapper object 524 as a parameter of the request. In this way, embedding mapper objects 524 within memory layout objects may facilitate a more logical and intuitive user experience.

In an embodiment, a projected object 526 is a runtime object that represents (a) information projected to the runtime object from a region of memory and/or (b) information that has been projected from the runtime object to a region of memory. For example, a projected object 526 may be a runtime object representing information extracted from a region of memory by a get method provided by a mapper object 524, and/or the projected object 526 may be a runtime object representing information that is to be written to a region of memory by a set method provided by a mapper object 524. A projected object 526 may be created by invoking a method of a mapper reference type on a mapper object 524. In an example, a projected object 526 is an instance of a class (e.g., a record class or another variety of class) that is mapped to a memory layout object by a mapper object 524. In another example, a projected object 526 is an interface object of an interface that is mapped to a memory layout object by a mapper object 524. A projected object 526 may be projected to or from a region of memory backing a domestic memory segment object 512, or the projected object 526 may be projected to or from to a region of memory backing a foreign memory segment object 512. Note that a program instance can use a projected object 526 to interact with information projected from foreign memory 530 (e.g., raw memory) in the same manner that the program instance might interact with the information represented by a standard runtime object. As an example, consider a memory segment object 512 that is backed by a region of foreign memory 530 (i.e., a foreign memory segment object 512). In this example, a program instance could interact with a dataset stored to the region of foreign memory 530 by calling methods of a memory segment reference type on the foreign memory segment object 512; however, these methods may require the program instance to specify the actual address of the dataset in the region of foreign memory, and writing the code of a program in terms of physical addresses in foreign memory 530 may be undesirable in some applications. For the purposes of this example, assume that the program instance instead calls a get method of a mapper reference type on a mapper object 524 to create a projected object 526 presenting the dataset stored to the region of foreign memory 530. In this example, the program instance can subsequently use the projected object 526 to interact with the dataset in the same manner the program instance would interact with information represented by a runtime object abstracting information stored within managed memory area 510 (e.g., without needing to specify an actual address in memory). For instance, the program instance can read from the dataset in this example simply by calling the name of a method on the projected object 526. Furthermore, in this example and depending on the variety of the projected object 526, the program instance may write to the dataset simply by calling the name of another method on the projected object 526. Note that changing a value held by a projected object 526 does not necessarily trigger any change to the state of the value as it exists in a region of memory that has previously been projected to the projected object 526. However, if a program instance desires a change to a projected valued by a projected object 526 to be carried over to a corresponding value residing within a region of memory, the program instance can call a set method of a mapper reference type on a mapper object 524 to do so.

In an embodiment, a mapper object 524 maps a record class to a group layout object 516. The mapper object 524 provides a get method that (a) extracts relevant values from a region of memory backing a source memory segment object 512 and (b) generates a record instance (i.e., a projected object 526) to represent the relevant values in managed memory area 510. The get method accepts, as an input parameter, a source memory segment object 512. Additionally, the get method may accept a positional value as another input parameter. The mapper object 524 further provides a set method that (a) copies relevant values from an instance of the record class and (b) writes the relevant values to a region of memory backing a target memory segment object 512. The set method writes to the region of memory backing the target memory segment object 512 in a manner that conforms to the specifications of the group layout object 516. The set method accepts, as input parameters, (a) a target memory segment object 512 and (b) a record instance. Additionally, the set method may accept a positional value as another input parameter.

In an embodiment, a mapper object 524 that maps an interface to a group layout object 516 provides (a) get method(s) for projecting to internal interface objects and (b) set method(s) for projecting from internal interface objects. As used herein, the term “internal interface object” refers to a projected object 526 that wraps a memory segment object 512 that is internally-allocated by a method of a mapper object 524. In this embodiment, a get method of the mapper object 524 may accept, as input parameters, (a) a segment allocator object that is used to allocate the new memory segment object 512 and/or (b) other information. In an example, a successful invocation of the get method returns an internal interface object that is projected from the new memory segment object 512 that was internally allocated by the get method. Furthermore, in this embodiment, a set method of the mapper object 524 may accept, as input parameters (a) a target memory segment object 512, (b) an interface object of the interface that wraps a source memory segment object 512, (c) a positional value, and/or (d) other information. Further consider the above example, and assume that the internal interface object is an input parameter to an invocation of the set method in this example. Successfully invoking the set method in this example may result in relevant values being copied from the region of memory backing the internally-allocated memory segment object 512 and written to the region of memory backing the target memory segment object 512.

In an embodiment, a mapper object 524 that maps an interface to a group layout object 516 provides (a) get method(s) for projecting to external interface objects and (b) set method(s) for projecting from external interface objects. As used herein, the term “external interface object” refers to a projected object 526 that is projected from a pre-existing memory segment object 512. In other words, an external interface object that is created by a get method does not wrap a memory segment object 512 that was internally-allocated by that get method. In this embodiment, a get method of the mapper object 524 may accept, as input parameters, (a) a pre-existing memory segment object 512 (i.e., a source memory segment object 512), (b) a positional value, and/or (c) other information. In an example, a successful invocation of the get method returns an external interface object that is projected from the pre-existing memory segment object 512. Furthermore, in this embodiment, a set method of the mapper object 524 may accept, as input parameters, (a) a target memory segment object 512, (b) an interface object of the interface, (c) a positional value, and/or (d) other information. Further consider the above example, and assume that the external interface object is an input parameter to an invocation of the set method. In this example, if the target memory segment object 512 is different than the pre-existing memory segment object 512 that is projected to the external interface object, successfully invoking the set method results in relevant values being copied from the region of memory backing the pre-existing memory segment object 512 and stored to the region of memory backing the target memory segment object 512. In contrast, if the target memory segment object 512 is the pre-existing memory segment object 512 in this example, successfully executing the set method does not require any copying between sections of memory backing memory segment objects 512.

In an embodiment, foreign memory 530 is any data repository exterior to managed memory area 510. Foreign memory 530 is any type of storage unit and/or device (e.g., a file system, database, collection of tables, or any other storage mechanism) for storing data. Foreign memory 530 may include multiple different storage units and/or devices. If foreign memory 530 does include multiple different storage units and/or devices, the multiple different storage units and/or devices may or may not be of the same type or located at the same physical site. Foreign memory 530 may be implemented or executed on the same computing system as managed memory area 510. Additionally, or alternatively, foreign memory 530 may be implemented or executed on a computing system that is separate from managed memory area 510. Foreign memory 530 may be communicatively coupled to other components of system 500 via a direct connection and/or via a network. Foreign memory 530 is implemented in volatile memory, and/or foreign memory is implemented in persistent memory. Foreign memory 530 may include raw memory, and/or foreign memory 530 may include direct memory. Furthermore, foreign memory 530 includes native memory, and/or foreign memory 530 includes linear memory. As illustrated in FIG. 5, foreign memory 530 includes foreign data entities 532. Information describing foreign data entities 532 may be implemented across any of the components within the system 500 (those illustrated in FIG. 5 or otherwise). However, this information is illustrated within managed memory area 510 for purposes of clarity and explanation.

In an embodiment, a foreign data entity 532 is information stored exterior to managed memory area 510. Example foreign entities 532 include foreign libraries, foreign reference types, foreign objects, foreign functions, foreign data structures, foreign primitive data, and others. Note that a foreign data entity 532 may be specified in different programming language(s) than information residing within managed memory area 510. For example, a foreign function residing in foreign memory 530 may be specified in C/C++, and a method provided by a runtime object residing in managed memory area 510 may be specified in Java. Furthermore, note that threads executing methods of runtime objects residing in managed memory area 510 may need to interact with foreign data entities 532 residing in foreign memory 530.

### 4. Mapping a Reference Type to a Compound Layout Object

FIG. 6 is a flowchart illustrating example operations for mapping a reference type (referred to hereafter as the “outer reference type”) to a compound layout object (referred to hereafter as the “outer compound layout object”) in accordance with one or more embodiments. One or more operations illustrated in FIG. 6 may be modified, rearranged, or omitted. Accordingly, the particular sequence of operations illustrated in FIG. 6 should not be construed as limiting the scope of one or more embodiments.

In an embodiment, the system receives a request for a mapper object (referred to hereafter as the “parent mapper object”) that maps the outer reference type to the outer compound layout object (Operation 602). The outer reference type is a record class, a class, an interface, or another variety of reference type. The outer compound layout object is a group layout object, a sequence layout object, or another variety of compound layout object. The request for the parent mapper object invokes a method of a mapper reference type (e.g., a factory method, a constructor method, etc.). In an example, the request is an invocation of a factory method that is declared by a mapper reference type (e.g., an of record method, an of interface method, etc.). In this example, the invocation of the factory method specifies a record class or an interface as a first parameter of the request (i.e., the outer reference type), and the invocation of the factory method specifies a group layout object as a second parameter of the request (i.e., the outer compound layout object). In another example, the request is an invocation of a method of the mapper reference type, and the invocation specifies either (a) the outer reference type as a parameter of the request or (b) the outer compound layout object as a parameter of the request. If the invocation specifies the outer reference type as a parameter of the request in this other example, the system infers the outer compound layout object that is to be mapped to the outer reference type. In yet another example, the request is an invocation of a method of the mapper reference type, and the invocation specifies both (a) a reference type and (b) a memory layout object. However, in this example, either (a) the reference type is more complex than the memory layout object or (b) the memory layout object is more complex than the reference type. If the memory layout object lacks specificity relative to the reference type in this example, the system treats that memory layout object as a missing parameter. Accordingly, the system of this example infers a new memory layout object (i.e., the outer compound layout object) to replace the memory layout object that was specified as a parameter of the request. On the other hand, if the reference type lacks specificity relative to memory layout object, the system treats the reference type as a missing parameter. In this alternative scenario, the system of this example infers a new reference type (i.e., the outer reference type) to replace the reference type that was specified as a parameter of the request.

In an embodiment, the system identifies element(s) of the outer reference type, and the system identifies constituent layout object(s) of the outer compound layout object (Operation 604). Depending on the variety of the outer reference type (e.g., a record class, a standard class, an interface, etc.), an element of the reference type is a field, a method, or another element of the reference type. To identify an element of the reference type, the system may apply reflective analysis to the reference type, or the system may inspect the reference type through another mechanism. Depending on the variety of compound layout object (e.g., a group layout object, a sequence layout object, etc.), a constituent layout object is a member layout object, an element layout object, or another variety of constituent layout object. To identify a constituent layout object of the compound layout object, the system may call a method of the compound layout object, or the system may inspect the compound layout object through another mechanism. As an example, assume that (a) the outer reference type is a record class and (b) the outer compound layout object is a group layout object. In this example, the system calls a method of a reflection API (e.g., a get record components method) to identify the components (i.e., fields) of the record class, and the system calls a method of a group layout interface (e.g., a member layouts method) on the group layout object to identify the member layout objects of the group layout object.

In an embodiment, the system generates a set of mapping(s) between element(s) of the outer reference type and constituent layout object(s) of the outer compound layout object (Operation 606). The system generates a mapping between an element of the outer reference type and a constituent layout object of the outer compound layout object based on the element and the constituent layout object having identical, similar, and/or complimentary attribute(s). For instance, the system may generate a mapping between an element of the outer reference type and a constituent layout object of the outer compound layout object based on the element and the constituent layout object (a) having the same name, (b) accepting the same or equivalent types, and/or (c) having other associations. The system may include a mapping in the set of mappings for each element of the outer reference type that matches a constituent layout object of the outer compound layout object. As an example, assume that (a) the outer reference type is a record class and (b) the outer compound layout object is a group layout object. In this example, the system generates multiple mappings between the multiple components of the record class and the multiple member layout objects of the group layout object. The system of this example matches a component of the record class with a member layout object of the group layout object based on the component and the member layout object sharing the same name and/or accepting the same or equivalent types. As another example, assume that (a) the outer reference type is an interface and (b) the outer compound layout object is a sequence layout object. In this example, the system generates a single mapping between a single method of the interface and a single element layout object of the sequence layout object. The system of this example matches the method to the clement layout object based on the method and the element layout object sharing the same name and/or accepting the same or equivalent types.

While mapping elements of the outer reference type to constituent layout objects of the outer compound layout object, the system, according to an embodiment, may treat an element of the outer reference type as a missing element. Additionally, or alternatively, the system may treat a constituent layout object of the outer compound layout object as a missing constituent layout object. The system may treat an element as missing from the outer reference type if that clement is an undesirable match for a corresponding constituent layout object. Similarly, the system may treat a constituent layout object as missing from the outer compound layout object if that constituent layout object is an undesirable match for a corresponding element. If an element is treated as missing, the system may infer a new element to replace that element. If a constituent layout object is treated as missing, the system may infer a new constituent layout object to replace that constituent layout object.

If an element of a reference type (e.g., the outer reference type) is less specific than a corresponding constituent layout object of a compound layout object (e.g., the outer compound layout object), the system, according to an embodiment, treats that element as missing from the reference type. As an example, consider (a) a reference type that is an element of the outer reference type (i.e., an inner reference type) and (b) a corresponding memory layout object that is a constituent layout object of the outer compound layout object. In this example, the reference type and the memory layout object may have matching names; however, the reference type is a relatively basic reference type (e.g., an Object type) whereas the memory layout object is comparatively complex (e.g., a struct layout object). Compared to the memory layout object, the reference type of this example lacks specificity with regard to fields, accepted data types, and/or other characteristics. Accordingly, the system of this example treats the reference type as a missing element of the outer reference type, and the system infers a new reference type based on the characteristics of the memory layout object. The system of this example then maps the newly-inferred reference type to the memory layout object.

If a constituent layout object of a compound layout object (e.g., the outer compound layout object) is less specific than a corresponding element of a reference type (e.g., the outer reference type), the system, according to an embodiment, treats that constituent layout object as missing from the compound layout object. As an example, consider (a) a reference type that is an element of the outer reference type and (b) a corresponding memory layout object that is a constituent layout object of the outer compound layout object. In this example, the reference type and the memory layout object may have matching names; however, the memory layout object is a relatively opaque memory layout object (e.g., a padding layout object) whereas the reference type is comparatively complex (e.g., a record class). In this example, the reference type is characterized by fields, accepted data types, and other attributes. However, the memory layout object of this example fails to specify corresponding attributes (e.g., member layout objects, carrier types, etc.). Accordingly, the system of this example treats the memory layout object as a missing constituent layout object of the outer compound layout object, and the system infers a new memory layout object based on the characteristics of the reference type. The system of this example then maps the newly-inferred memory layout object to the reference type.

Additional embodiments and/or examples relating to inferences that may be made by the system are described below in Section 5.5, titled “Example Inferences.”

Note that, in some cases, it may be that (a) there is no matching constituent layout object of the outer compound layout object for an element of the outer reference type and/or (b) there is no matching element of the outer reference type for a constituent layout object of the outer compound layout object. In this scenario, the system, according to an embodiment, either (a) prevents the creation of the parent mapper object (e.g., by throwing an exception) or (b) permits the creation of the parent mapper object to continue. In the latter scenario, the system may be configured to resolve non-matching elements and/or constituent layout objects by various means. For instance, in the latter scenario, the system may (a) map an element or constituent layout object that lacks a counterpart to a default value (e.g., zero), (b) configure the parent mapper object to project information unidirectionally, and/or (c) take other corrective actions. As an example, assume that the number of elements possessed by the outer reference type is greater than the number of constituent layout objects possessed by the outer compound layout object. In this example, the system configures the parent mapper object to offer methods for writing to a section of memory that conforms to the outer compound layout object (i.e., set methods); however, the parent mapper object may not offer methods for projecting information in the opposite direction (i.e., get methods). If the parent mapper object of this example does offer a get method, that get method may be configured to populate an element (e.g., a field) that lacks a matching constituent layout object with a default value (e.g., zero). As another example, assume that the number of elements possessed by the outer reference type is less than the number of constituent layout objects possessed by the outer compound layout object. In this other example, the system configures the parent mapper object to offer methods for extracting information from a section of memory that conforms to the outer compound layout object (i.e., get methods); however, the parent mapper object may not offer methods for writing to a section of memory that conforms to the compound layout object (i.e., set methods). If the parent mapper object does offer a set method in this other example, that set method may be configured to populate a default value to a subregion of memory that is organized according to a constituent layout object that lacks a matching element.

In an embodiment, the system selects a mapping from the set of mapping(s) (Operation 608). The selected mapping corresponds to an element of the outer reference type that matches a constituent layout object of the outer compound layout object. The element is a field (e.g., a record component), a method (e.g., a method declared by an interface), or another variety of element. The constituent layout object is a value layout object, a group layout object, a sequence layout object, and/or another variety of memory layout object. Note that if the constituent layout object is also a compound layout object (e.g., a group layout object or a sequence layout object) (i.e., an inner compound layout object), the element of the reference type indicates another reference type (i.e., an inner reference type).

In an embodiment, the system determines if the constituent layout object is an inner compound layout object, and the system proceeds to another operation based on the determination (Operation 610). If the constituent layout object is an inner compound layout object (YES at Operation 610), the system proceeds to Operation 612. For example, if the constituent layout object is a group layout object or a sequence layout object, the system proceeds to Operation 612. Alternatively, if the constituent layout object is not an inner compound layout object (NO at Operation 610), the system proceeds to Operation 616. For example, if the constituent layout object is a value layout object or a padding layout object, the system proceeds to Operation 616.

In an embodiment, the constituent layout object is an inner compound layout object, and the system generates another mapper object (referred to hereafter as the “child mapper object”) (Operation 612). Recall that if a constituent object is an inner compound layout object, the matching element of the outer reference type indicates an inner reference type. Accordingly, the system generates the child mapper object to map the inner reference type to the inner compound layout object. The resulting child mapper object will provide methods (e.g., get methods, set methods, etc.) for projecting information between a runtime object of the inner reference type and a subregion of memory that is organized in accordance with the inner compound layout object. Note that in this scenario, the subregion of memory is a part of a region of memory that is organized in accordance with the outer compound layout object. It should also be noted that a constituent layout object of the inner compound layout object may, in turn, also be a compound layout object. Accordingly, the system may need to generate additional mapper objects (i.e., grandchild mapper objects, great grandchild mapper objects, etc.) while generating the child mapper object. Descendant mapper objects of any depth (e.g., child mapper objects, grandchild mapper objects, great grandchild mapper objects, etc.) may be cached globally. Additionally, or alternatively, descendant mapper objects of any depth may be included within a parent mapping computation (e.g., if the outer compound layout object includes inner compound layout objects that have identical or similar characteristics).

To generate the child mapper object, the system, according to an embodiment, invokes a method (e.g., a factory method, a constructor method, etc.) of the mapper reference type (Operation 612a). Invoking the method in this suboperation may be similar to the invocation described above in Operation 602. Depending on the characteristics of the inner reference type and the characteristics of the inner compound layout object, the system invokes the same method that was invoked in Operation 602, or the system invokes a different method. The invocation of the method specifies the inner reference type as one parameter of the request, and the invocation of the method specifies the inner compound layout object as another parameter of the request. The system subsequently executes the instructions defined by the invoked method. While executing the method to create the child mapper object, the system is effectively performing separate occurrences of operations illustrated in FIG. 6 (e.g., Operation 604-Operation 624). As an example, assume that (a) the inner reference type is a record class and (b) the inner compound layout object is a group layout object. While executing the method to create the child mapper object in this example, the system may (a) identify components of the record class and member layout objects of the group layout object, (b) generate a set of mappings between the record components the member layout objects, (c) create grandchild mapper object(s), (d) create method handle objects to methods of a mapper reference type that are to be called on the grandchild mapper object(s), (e) create method handle objects to methods of a memory segment reference type that are to be called on a memory segment object, (f) generate methods for the child mapper object based on the method handle objects, and (g) return the child mapper object.

In an embodiment, the system creates method handle(s) for calling method(s) of the mapper reference type on the child mapper object (Operation 614). The system generates a single method handle(s) for a single method of the mapper reference type, or the system generates multiple method handles for multiple methods of the mapper reference type. The system may generate method handle(s) for get method(s) of the mapper reference type, set method(s) of the mapper reference type, and/or other method(s) of the mapper reference type. Note that the mapper reference type may declare multiple get methods, and the mapper reference type may declare multiple set methods. Additionally, or alternatively, the system may generate other mechanisms for invoking methods of the mapper reference type. For example, the system may directly generate a set of intermediate instructions (e.g., bytecode) for invoking a method of the mapper reference type, and the system may directly insert those intermediate instructions into the intermediate instructions of a method that is offered by the parent mapper object.

To generate a method handle object, the system, according to an embodiment, retrieves a method from the mapper reference type. If appropriate, the system may employ reflection or another mechanism to retrieve the method. Once the system has retrieved the method, the system generates a method handle object to the method, and the system modifies the method handle object to specify argument(s) for calling the method through the method handle object. For instance, the system may modify the method handle object to specify the child mapper object as the receiver of the method. In other words, the system may modify the method handle object to ensure that calling the method through the method handle object results in the method being called on the child mapper object. In addition to specifying the child mapper object as the receiver of the method, the system may generate a function for determining a positional value (e.g., an index value, an offset value, etc.) that can be input as a parameter to the method of the mapper reference type when the method is called on the child mapper object through the method handle object. Note that the method may be called on the child mapper object through the method handle object if a method is called on the parent mapper object. A positional value that is calculated by the function may depend on (a) the inner compound layout object's relative position within the outer compound layout object, (b) another positional value that is input as a parameter to the method called on the parent mapper object, and/or (c) other information. Furthermore, note that if the invocation of the method on the parent mapper object does not specify another positional value as a parameter, the function may simply return the inner compound layout object's position relative to the outer compound layout object. Having modified the method handle object and generated the function for determining a positional value, the system stores the method handle object and the function for later use. For example, the system may store the method handle object and the function within a record instance, and the system may organize the record instance into an array object. Note that the system may repeat the foregoing operations for multiple methods of the mapper reference type that may be called on the child mapper object (e.g., get methods, set methods, etc.).

In an embodiment, the system determines if the constituent layout object is a value layout object, and the system proceeds to another operation based on the determination (Operation 616). Recall that in this scenario, the system has previously determined that the constituent layout object is not a compound layout object. If the constituent layout object is a value layout object (YES at Operation 616), the system proceeds to Operation 618. Alternatively, if the constituent layout object is not a value layout object (NO at Operation 616), the system may proceed to Operation 620. For example, if the constituent layout object is a padding layout object, the system may proceed to Operation 620. Recall that a padding layout object describes a region of memory that stores padding. Accordingly, the system does not need to generate method handle object(s) for the constituent layout object if the constituent layout object is a padding layout object.

In an embodiment, the constituent layout object is a value layout object, and the system generates method handles for method(s) of a memory segment reference type (Operation 618). The system generates a single method handle for a single method of the memory segment reference type, or the system generates multiple method handles for multiple methods of the memory segment reference type. The system may generate method handles for get method(s) of the memory segment reference type, set method(s) of the memory segment reference type, and/or other method(s) of the memory segment reference type. Note that the memory segment reference type may declare multiple get methods, and the memory segment reference type may declare multiple set methods. Recall that value layout objects generally specify a carrier. Note that the particular methods of the memory segment type that the system creates method handles for may depend on the carrier of the value layout object (i.e., the constituent layout object). For example, if the carrier of the value layout object is a byte class, the system may create a method handle for a get method of the memory segment reference type that is used for reading bytes. Additionally, or alternatively, the system may generate other mechanisms for invoking methods of the mapper reference type. For example, the system may directly generate a set of intermediate instructions (e.g., bytecode) for invoking a method of the mapper reference type, and the system may directly insert those intermediate instructions into the intermediate instructions of a method that is offered by the parent mapper object.

To generate a method handle object, the system, according to an embodiment, retrieves a method from the memory segment reference type. If appropriate, the system may employ reflection or another mechanism to retrieve the method. Once the system has retrieved the method, the system generates a method handle object to the method, and the system modifies the method handle object to specify argument(s) for calling the method through the method handle object. For instance, the system may modify the method handle object to specify the value layout object as an input parameter for invoking the method through the method handle object. Recall that a get method or a set method of a memory segment reference type generally accepts a memory layout object as an input parameter. In addition to specifying the value layout object as an input parameter, the system may generate a function for determining a positional value (e.g., an index value, an offset value, etc.) that can be input as another parameter to the method when the method is invoked through the method handle object. Note that the method may be invoked through the method handle object if a method is called on the parent mapper object. As an example, assume that a get method of a mapper reference type is called on the parent mapper object. In this example, the get method of the mapper reference type called on the parent mapper object may, in turn, invoke a get method of the memory segment reference type on a memory segment object through the method handle object. A positional value that is calculated by the function may depend on (a) the value layout object's relative position within the outer compound layout object, (b) another positional value that is an input parameter to a method called on the parent mapper object that, in turn, calls the method of the memory segment reference type through the method handle object, and/or (c) other information. Note that if the invocation of the method on the parent mapper object does not specify another positional value, the function may simply return the value layout object's position relative to the outer compound layout object. Having modified the method handle object and/or generated the function for determining a positional value, the system stores the method handle object and the function for later use. For example, the system may store the method handle object and the function within a record instance, and the system may organize the record instance into an array object. Note that the system may repeat the foregoing process for multiple methods of the memory segment reference type.

In an embodiment, the system determines if there are remaining mappings in the set of mappings that require processing, and the system proceeds to another operation based on the determination (Operation 620). If the set of mappings contains additional mappings that require processing (YES at Operation 620), the system returns to Operation 608. Alternatively, if set of mappings does not contain any additional mappings that require processing (NO at Operation 620), the system proceeds to Operation 622.

In an embodiment, the system generates method(s) for the parent mapper object based on the method handle object(s) the system generated in previous operations (Operation 622). The system generates a single method for the parent mapper object, or the system generates multiple methods for the parent mapper object. The system may generate get method(s), set method(s), and/or other methods. Note that the system may generate multiple get methods for the parent mapper object, and the system may generate multiple set methods for the parent mapper object. The system generates method(s) for the parent mapper objects based on method handle(s) or other mechanisms that are generated by the system. For example, the system may generate methods based on sets of intermediate instructions that were generated by the system in previous operations, and/or the system may generate methods based on method handle objects that were generated by the system in previous operations.

The system, according to an embodiment, generates a method for the parent mapper object based on method handle object(s) corresponding to a constituent layout object of the outer compound layout object that is not a padding layout object. To generate a method for the parent mapper object, the system may rely on (a) method handle objects to methods of a mapper reference type, (b) method handle objects to methods of a memory segment reference type, (c) functions for calculating positional values to be input to methods of the mapper reference type and/or methods of the memory segment reference type, (d) other method handle objects or other functions, and/or (e) other information. In general, the system uses get method handle object(s) to formulate a get method for the parent mapper object, and the system uses set method handle object(s) to generate a set method for the parent mapper object. As a simple example, assume that (a) the system is generating a get method for the parent mapper object (referred to hereafter as the “parent get method”), (b) the outer reference type is a record class, and (c) the outer compound layout object is an outer struct layout object that possesses two member layout objects. In this example, the first member layout object is an inner struct layout object (i.e., an inner group layout object), and the second member layout object is a value layout object. To generate the parent get method in this example, the system retrieves from storage (e.g., an array object) (a) a first get method handle object to a get method of the mapper reference type, (b) a first function for generating a first positional value to be input to the get method of the mapper reference type, (c) a second get method handle object to a get method of the memory segment reference type, (d) a second function for generating a second positional value to be input to the get method of the memory segment reference type, and/or (c) other information. Recall that member layout objects of a struct layout object are laid out sequentially at separate starting positions. Accordingly, the first function will produce a different positional value than the second function in this example because the inner struct layout object has a different starting position than the value layout object. In this example, the first method handle object specifics a child mapper object as a receiver for the get method of the mapper reference type. Note that calling the get method of the mapper reference type on the child mapper object will trigger the invocation of other get methods corresponding to inner member layout objects of the inner struct layout object. Furthermore, in this example, the second method handle object specifies the value layout object as an input parameter for the method of the memory segment reference type. In this example, the system defines the parent get method to include (a) instructions for invoking the get method of the mapper reference type through the first method handle object while using the first positional value computed by the first function as an input parameter, (b) instructions for invoking the get method of the memory segment reference type through the second method handle object while using the second positional value computed by the second function as an input parameter, (c) instructions for aggregating a composite dataset based on a dataset returned by the get method of the mapper reference type and another dataset returned by the get method of the memory segment reference type, and (d) instructions for generating an instance of the record class (i.e., a projected object) that stores the composite dataset. The parent get method accepts a memory segment object as an input parameter. Note that the memory segment object specified with an invocation of the parent get method will be used as a receiver for any get methods of the memory segment reference type that are invoked through method handle objects as a result of the invocation of the parent get method. The parent get method may also accept a positional value as an input parameter. If the parent get method accepts a positional value as an input parameter, then the parent get method is further configured to use that positional value as an input to the first function and the second function.

In an embodiment, the system returns the parent mapper object (Operation 624). The parent mapper object provides methods that can be used to translate information between (a) projected objects associated with the outer reference type and (b) regions of memory backing memory segment objects that are described by the outer compound layout object. The parent mapper object may provide get method(s), set method(s), and/or other methods. Note that generating the parent mapper object may be relatively computationally expensive. However, once the parent mapper object is generated, the parent mapper object will not need to be generated again during runtime, and calling methods on the parent mapper object are computationally inexpensive.

### 5. Example Embodiment

A detailed example is described below for purposes of clarity. Components and/or operations described below should be understood as one specific example that may not be applicable to certain embodiments. Accordingly, components and/or operations described below should not be construed as limiting the scope of any of the claims.

### 5.1 Example Projection Operations

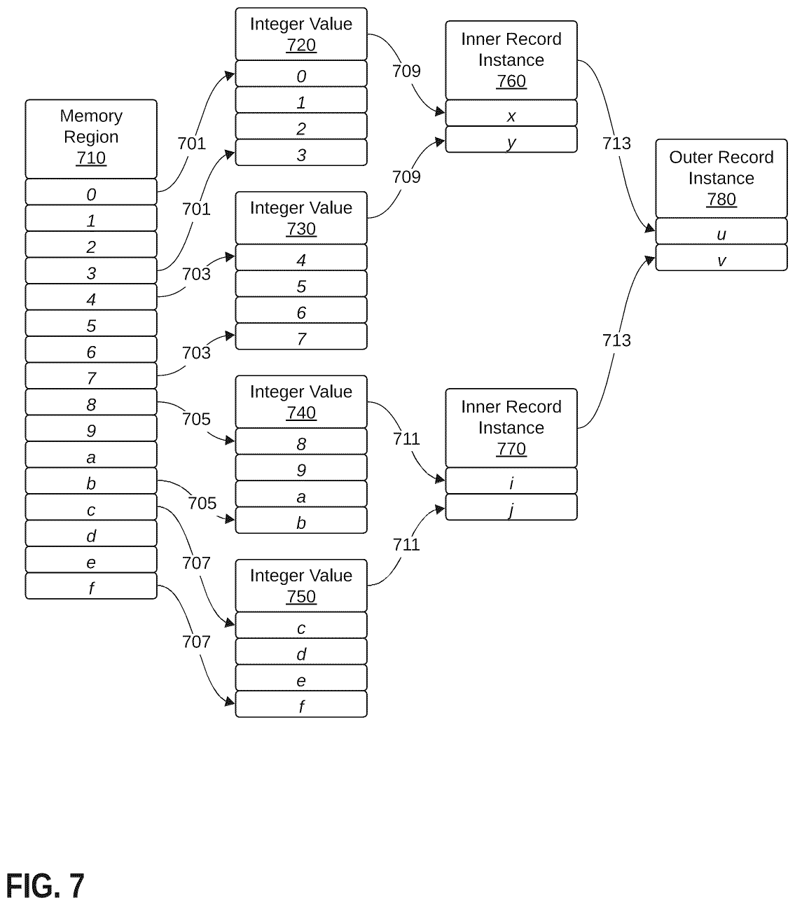

FIG. 7 illustrates an example set of operations that are performed in response to the calling of a get method declared by a mapper reference type in accordance with an example embodiment. The get method is called on a mapper object (referred to hereafter as the “parent mapper object”). The invocation of the get method on the parent mapper object specifies, as an input parameter, a memory segment object that is backed by memory region 710. The memory segment object is a foreign memory segment object, or the memory segment object is a domestic memory segment object. For the purposes of the example illustrated by FIG. 7, assume that the invocation of the get method on the parent mapper object does not specify a positional value as an input parameter. As illustrated in FIG. 7, memory region 710 includes bytes 0 through f. Information is stored to bytes 0 through f in a manner that conforms with the specifications of a struct layout object (referred to hereafter as the “outer struct layout object”). The parent mapper object maps a record class (referred to hereafter as the “outer record class”) to the outer struct layout object. The outer record class has two record components, and the outer struct layout object has two member layout objects. Both of the two record components refer to other record classes (referred to hereafter as “inner record classes”). Furthermore, both of the two member layout objects are also struct layout objects (referred to hereafter as “inner struct layout objects”). The components of the inner record classes are mapped to member layout objects of the inner struct layout objects by other mapper objects (referred to hereafter as “child mapper objects”). The invocation of the get method on the parent mapper object triggers the calling of get methods on the child mapper objects through get method handle objects, and the calling of the get methods on the child mapper objects triggers the calling of get methods on the memory segment object that is backed by the memory region 710 through other get method handle objects. One or more operations illustrated in FIG. 7 may be modified, rearranged, or omitted. Accordingly, the particular sequence of operations illustrated in FIG. 7 should not be construed as limiting the scope of one or more embodiments.

In an example embodiment, the system extracts integer value 720 from bytes 0 through 3 of memory region 710 (Operation 701). The extraction of integer value 720 from memory region 710 is performed pursuant to the instructions of a get method of the memory segment reference type called on the memory segment object backed by memory region 710. The get method call specifies a value layout object as one parameter of the request, and the get method call specifies a positional value as another parameter of the request. The value layout object is a member layout object of an inner struct layout object, and the value layout object describes the contents of bytes 0 through 3. In particular, the value layout object specifies a size of the integer value 720, the byte order of bytes 0 through 3, an alignment of the integer value 720, and an integer class carrier type. The positional value corresponds to the starting position of byte 0.

In an example embodiment, the system extracts integer value 730 from bytes 4 through 7 of memory region 710 (Operation 703). The extraction of integer value 730 from memory region 710 is performed pursuant to the instructions of a get method of a memory segment reference type called on the memory segment object backed by memory region 710. The get method call specifies a value layout object as one parameter of the request, and the get method call specifies a positional value as another parameter of the request. The value layout object is a member layout object of an inner struct layout object, and the value layout object describes the contents of bytes 4 through 7. In particular, the value layout object specifies the size of integer value 730, the byte order of bytes 4 through 7, an alignment of integer value 730, and an integer carrier type. The positional value corresponds to the starting position of byte 4.

In an example embodiment, the system extracts integer value 740 from bytes 8 through b of memory region 710 (Operation 705). The extraction of integer value 740 from memory region 710 is performed pursuant to the instructions of a get method of the memory segment reference type that is called on the memory segment object backed by memory region 710. The get method call specifies a value layout object as one parameter of the request, and the get method call specifies a positional value as another parameter of the request. The value layout object is a member layout object of an inner struct layout object, and the value layout object describes the contents of bytes 8 through b. In particular, the value layout object specifies the size of integer value 740, the byte order of bytes 8 through b, an alignment of integer value 740, and an integer class carrier type. The positional value corresponds to the starting position of byte 8.

In an example embodiment, the system extracts integer value 750 from bytes c through f of memory region 710 (Operation 707). The extraction of integer value 750 from memory region 710 is performed pursuant to the instructions of a get method of the memory segment reference type that is called on the memory segment object backed by memory region 710. The get method call specifies a value layout object as one parameter of the request, and the get method call specifies a positional value as another parameter of the request. The value layout object is a member layout object of an inner struct layout object, and the value layout object describes the contents of bytes c through f. In particular, the value layout object specifies the size of integer value 750, the byte order of bytes c through f, an alignment of integer value 750, and an integer class carrier type. The positional value corresponds to the starting position of byte c.

In an example embodiment, the system stores integer value 720 to component x of inner record instance 760, and the system stores integer value 730 to component y of inner record instance 760 (Operation 709). The storing of integer value 720 and integer value 730 to inner record instance 760 is performed pursuant to the instructions of a get method of the mapper reference type called on a child mapper object. The child mapper object maps an inner record class (i.e., the blueprint for inner record instance 760) to an inner struct layout object that describes the contents of bytes 0 through 7 of memory region 710. In particular, the child mapper object maps component x of the inner record class to the value layout object describing bytes 0 through 3 of memory region 710, and the child mapper object maps component y of the inner record class to the value layout object describing bytes 4 through 7 of memory region 710. The get method call on the child mapper object specifies the memory segment object backed by memory region 710 as one parameter of the request, and/or the get method call on the child mapper object specifies a positional value corresponding to the position of byte 0 as another parameter of the request.

In an example embodiment, the system stores integer value 740 to component i of inner record instance 770, and the system stores integer value 750 to component j of inner record instance 770 (Operation 711). The storing of integer value 740 and integer value 770 to inner record instance 770 is performed pursuant to the instructions of a get method of the mapper reference type called on a child mapper object. The child mapper object maps an inner record class (i.e., the blueprint for inner record instance 770) to an inner struct layout object that describes the contents of bytes 8 through f. In particular, the child mapper object maps component i of the inner record class to the value layout object describing bytes 8 through b of memory region 710, and the child mapper object maps component j of the inner record class to the value layout object describing bytes c through f of memory region 710. The get method call on the child mapper object specifies the memory segment object backed by memory region 710 as one parameter of the request, and the get method call on the child mapper object specifies a positional value corresponding to the position of byte 8 as another parameter of the request.

In an example embodiment, the system stores inner record instance 760 to component u of outer record instance 780, and the system stores inner record instance 770 to component v of outer record instance 780 (Operation 713). The storing of inner record instance 760 and inner record instance 770 to outer record instance 780 is performed pursuant to instructions of the get method called on the parent mapper object. Recall that the parent mapper object maps the outer record class to the outer struct layout object. More specifically, the parent mapper object maps component u of the outer record class to the inner struct layout object describing the contents of bytes 0 through 7 of memory region 710, and parent mapper object maps component v of the outer record class to the inner struct layout object describing bytes 8 through f of memory region 710.

### 5.2 Example Operations for Projecting a Record Instance

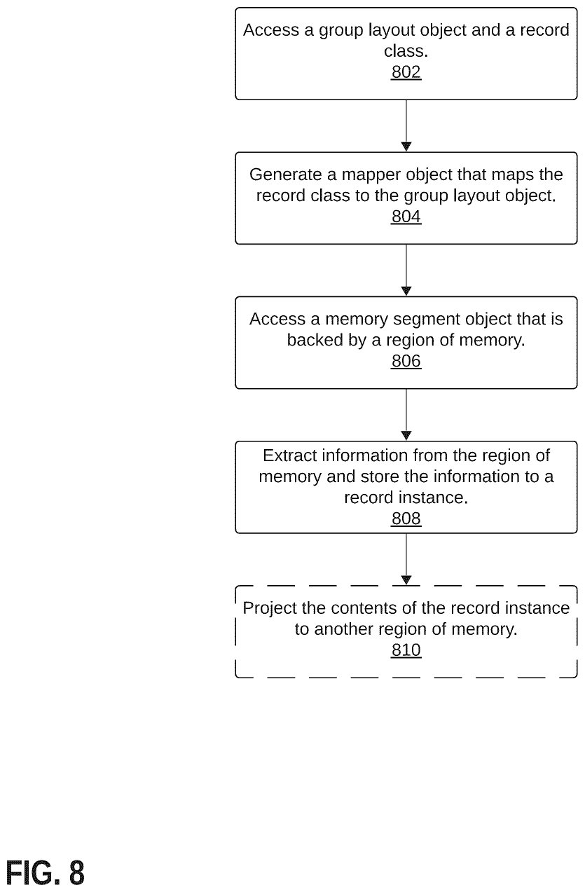

FIG. 8 illustrates an example set of operations for projecting information between region(s) of memory and a record instance in accordance with an example embodiment. One or more operations illustrated in FIG. 8 may be modified, rearranged, or omitted. Accordingly, the particular sequence of operations illustrated in FIG. 8 should not be construed as limiting the scope of one or more embodiments. At various points in this Section 5.2, example source code corresponding to operations illustrated in FIG. 8 is provided to the reader. To provide consistent examples, the example source code is specified uniformly in Java. However, the techniques described in this Section 5.2 are equally applicable to other programing languages.

In an example embodiment, the system accesses a group layout object, and the system accesses a record class (Operation 802). The system accesses the group layout object and the record class pursuant to the instructions of a program instance. Example source code corresponding to the instructions of an example program instance is included below. In the example provided below, the program requests a group layout object named “POINT,” and the program requests a record class named “Point.” In this example, the group layout object is a struct layout object that has a member layout object named “x” and another member layout object named “y.” Furthermore, in this example, the record class has a component named “x,” and the record class has another component named “y.”

static final GroupLayout POINT =
memoryLayout.structLayout(JAVA_INT.withName(“x”) ,
JAVA_INT.withName(“y”));
public record Point(int x, int y){ }

In an example embodiment, the system generates a mapper object that maps the record class to the group layout object (Operation 804). Operations that may be performed by the system to generate the mapper object are described above in Section 5, titled “Mapping a Reference Type to a Compound Layout Object.” The system generates the mapper object pursuant to the instructions of a program instance. Example source code corresponding to the instructions of an example program instance is provided below. In the example provided below, the program requests the mapper object named “recordMapper” by calling a method of a mapper reference type. More specifically, the program of this example calls a static factory method named “ofRecord” that is defined by a mapper interface named “SegmentMapper.” In this example, the program specifies the record class (i.e., Point) as one parameter of the request, and the program specifies the group layout object (i.e., POINT) as another parameter of the request.

SegmentMapper<Point> recordMapper =
SegmentMapper.ofRecord(Point.class, POINT);

In an example embodiment, the system generates a memory segment object that is backed by a region of memory (Operation 806). The system generates the memory segment object pursuant to the instructions of a program instance. Example source code corresponding to the instructions of an example program instance is provided below. In the example provided below, the program requests a memory segment object named “segment.” To this end, the program of this example calls a static factory method of a memory segment interface. In this example, the program requests a memory segment object that is backed by a heap-allocated integer array object. In other words, the program requests a domestic memory segment object in this example.

MemorySegment segment = MemorySegment.ofArray
(new int[ ]{3, 4, 0, 0});

In an example embodiment, the system extracts relevant information from the region of memory, and the system generates an instance of the record class to store the relevant information (Operation 808). In other words, the system projects the contents of the region of memory to the record instance. Note that the record instance is a projected object. The system extracts the information and generates the new record instance pursuant to the instructions of a program instance. Example source code corresponding to the instructions of an example program instance is provided below. In the example provided below, the program requests a record instance named “point” by calling a get method on the mapper object that maps the record class to the group layout object (i.e., recordMapper). The program specifies the memory segment object (i.e., segment) as an input parameter of the request.

Point point = recordMapper.get(segment); // Point[x=3, y=4]

In an example embodiment, the system may project the contents of the record instance to another region of memory (Operation 810). Stated differently, the system may write the contents of the record instance to another region of memory that backs another memory segment object. The system writes the contents of the record instance to the other region of memory pursuant to the instructions of a program instance. Example source code corresponding to the instructions of an example program instance is provided below. In the example provided below, the program requests a new memory segment object named “otherSegment.” To this end, the program of this example calls a method for allocating the new memory segment object from an arena, and the program specifies an arena that automatically releases memory managed by the arena when the arena is closed. While calling the allocate method in the example below, the program specifies that the new memory segment object should correspond to the specifications of a sequence layout, and the method call further specifies that (a) the group layout object (i.e., POINT) is the element layout object of the sequence layout object and (b) the group layout object is repeated twice within the sequence layout object. Having defined the new memory segment object, the program of this example calls a set method on the mapper object (i.e., recordMapper). In this example, the program specifies that the contents of the record instance (i.e., point) should be written to the other region of memory backing the new memory segment object (i.e., otherSegment) starting at the second index slot (i.e., 1) of the new memory segment object. Note that Java uses zero-based indexing.

MemorySegment otherSegment =
Arena.ofAuto( ).allocate(MemoryLayout.sequenceLayout(2, POINT));
recordMapper.setAtIndex(otherSegment, 1, point); // otherSegment: 0,
0, 3, 4

### 5.3 Example Operations for Projecting an Internal Interface Object

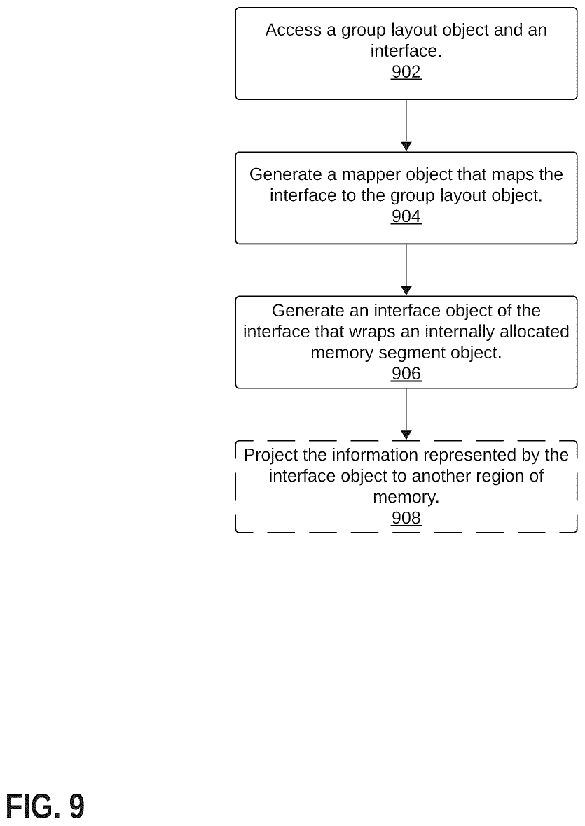

FIG. 9 illustrates an example set of operations for projecting information between region(s) of memory and an internal interface object in accordance with an example embodiment. One or more operations illustrated in FIG. 9 may be modified, rearranged, or omitted. Accordingly, the particular sequence of operations illustrated in FIG. 9 should not be construed as limiting the scope of one or more embodiments. At multiple points in this Section 5.3, example source code corresponding to operations illustrated in FIG. 9 is provided to the reader. To provide consistent examples, the example source code is specified uniformly in Java. However, the techniques described in this Section 5.3 are equally applicable to other programing languages.

In an example embodiment, the system accesses a group layout object, and the system accesses an interface (Operation 902). The system accesses the group layout object and the interface pursuant to the instructions of a program instance. Example source code corresponding to the instructions of an example program instance is included below. In the example provided below, the program requests a group layout object named “POINT,” and the program provides an interface named “PointAccessor.” In this example, the group layout object is a struct layout object that has a member layout object named “x” and another member layout object named “y.” Furthermore, in this example, the interface declares a getter method named “x,” a setter method named “x,” a getter method named “y,” and a setter method named “y.”

```
static final GroupLayout POINT =
MemoryLayout.structLayout(JAVA_INT.withName(“x”) ,
JAVA_INT.withName(“y”));
public interface PointAccessor {
    int x( );
    void x(int x);
    int y( );
    void y(int x);
}
```

In an example embodiment, the system generates a mapper object that maps the interface to the group layout object (Operation 904). Operations that may be performed by the system to generate the mapper object are described above in Section 5, titled “Mapping a Reference Type to a Compound Layout Object.” The system generates the mapper object pursuant to the instructions of a program instance. Example source code corresponding to the instructions of an example program instance is provided below. In the example provided below, the program requests the mapper object named “mapper” by calling a method of a mapper reference type. More specifically, the program of this example calls a static factory method named “ofInterface” that is defined by a mapper interface named “SegmentMapper.” In this example, the program specifies the interface (i.e., PointAccessor) as one parameter of the request, and the program specifies the group layout object (i.e., POINT) as another parameter of the request.

SegmentMapper<PointAccessor> mapper =
SegmentMapper.ofInterface(PointAccessor.class, POINT);

In an example embodiment, the system projects the contents of a region of memory backing an internally allocated memory segment object to an interface object (Operation 906). Stated differently, the system generates an interface object that wraps the internally allocated memory segment object (i.e., an internal interface object). The system generates the internal interface object pursuant to the instructions of a program instance. Example source code corresponding to the instructions of an example program instance is provided below. In the example provided below, the program requests an arena object named “arena,” and the program requests an interface object named “point” that is backed by a new memory segment object that is allocated by the arena object. To this end, the program of this example calls a get method of the segment mapper interface on the mapper object (i.e., mapper) while specifying the arena object as an input parameter of the request. Furthermore, in this example, the program calls a setter method on the internal interface object to store the value three to an x field of the internal interface object, and the program calls a setter method on the internal interface object to store the value four to a y field of the internal interface object. Note that, in another example, the arena object, rather than being specified as an input parameter to an invocation of the get method as is shown below, might alternatively be provided when the mapper object is constructed.

```
try(var arena = Arena.ofConfined( )) {
  PointAccessor point = mapper.get(arena); // Point[x=0, y=0]
  point.x(3); // Point[x=3, y=0]
  point.y(4); // Point[x=3, y=4]
...
```

In an example embodiment, the system may project the information represented by the internal interface object to another region of memory (Operation 908). Stated differently, the system may access another memory segment object, and the system may write the information represented by the internal interface object to the region of memory backing the other memory segment object. The system generates the other memory segment object and writes to the other region of memory pursuant to the instructions of a program instance. Example source code corresponding to the instructions of an example program instance is provided below. In the example below, the program requests another memory segment object named “otherSegment” by calling a method for allocating a new memory segment object from an arena. While calling the allocate method in the example below, the program specifies that the new memory segment object should correspond to the specifications of a sequence layout object, and the method call further specifies that (a) the group layout object (i.e., POINT) is the element layout object of the sequence layout object and (b) the group layout object is repeated twice within the sequence layout object. In addition, the program of this example calls a set method on the mapper object (i.e., recordMapper). In this example, the program specifies that the contents of the interface object (i.e., point) should be written to the other region of memory backing the other memory segment object (i.e., otherSegment) starting at the second index slot (i.e., 1) of the new memory segment object. Note that Java uses zero-based indexing. It should also be noted that the second index slot corresponds to the second repetition of the group layout object within the sequence layout object.

...
MemorySegment otherSegment =
arena.allocate(MemoryLayout.sequenceLayout(2, POINT)); //
otherSegment: 0,0,0,0
mapper.setAtIndex(otherSegment, 1, point); // otherSegment: 0, 0, 3, 4
}

### 5.4 Example Operations for Projecting an External Interface Object

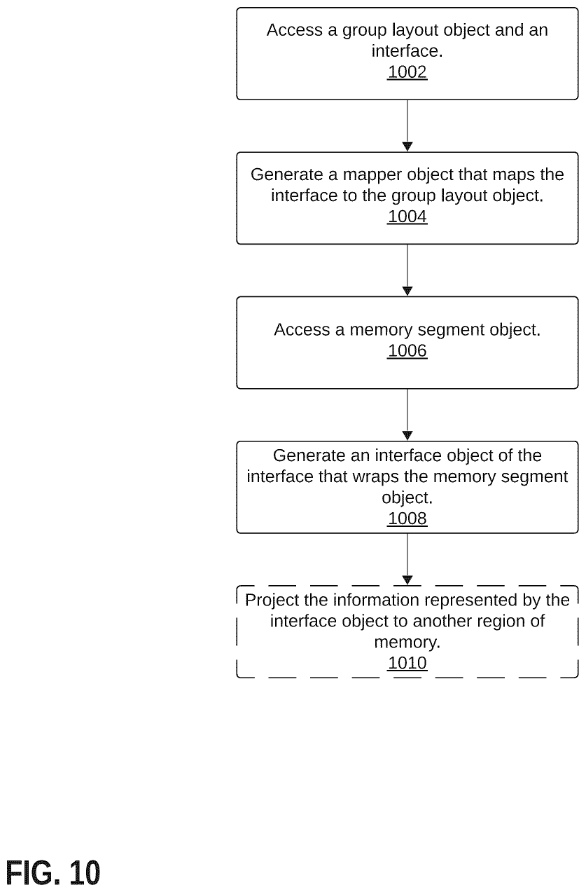

FIG. 10 illustrates an example set of operations for projecting between region(s) of memory and an external interface object in accordance with an example embodiment. One or more operations illustrated in FIG. 10 may be modified, rearranged, or omitted. Accordingly, the particular sequence of operations illustrated in FIG. 10 should not be construed as limiting the scope of one or more embodiments. At multiple points in this Section 5.4, example source code corresponding to operations illustrated in FIG. 10 is provided to the reader. To provide consistent examples, the example source code is specified uniformly in Java. However, the techniques described in this Section 5.4 are equally applicable to other programing languages.

In an example embodiment, the system accesses a group layout object, and the system accesses an interface (Operation 1002). The system generates the group layout object and caches the interface pursuant to the instructions of a program instance. Example source code corresponding to the instructions of an example program instance is included below. In the example provided below, the program requests a group layout object named “POINT,” and the program provides an interface named “Point.” In this example, the group layout object is a struct layout object that has a member layout object named “x” and another member layout object named “y.” Furthermore, in this example, the interface declares a getter method named “x,” a setter method named “x,” a getter method named “y,” and a setter method named “y.”

```
static final GroupLayout POINT =
MemoryLayout.structLayout(JAVA_INT.withName(“x”),
JAVA_INT.withName(“y”));
public interface Point {
  int x( );
  void x(int x);
  int y( );
  void y(int x);
}
```

In an example embodiment, the system generates a mapper object that maps the interface to the group layout object (Operation 1004). Operations that may be performed by the system to generate the mapper object are described above in Section 5, titled “Mapping a Reference Type to a Compound Layout Object.” The system generates the mapper object pursuant to the instructions of a program instance. Example source code corresponding to the instructions of an example program instance is provided below. In the example provided below, the program requests a mapper object named “mapper” by calling a method declared by a mapper reference type. More specifically, the program of this example calls a static factory method named “ofInteface” that is defined by a mapper interface named “SegmentMapper.” In this example, the program specifies the interface (i.e., Point) as one parameter of the request, and the program specifies the group layout object (i.e., POINT) as another parameter of the request.

SegmentMapper<Point> mapper = SegmentMapper.ofInterface(Point.class,
POINT);

In an example embodiment, the system accesses a memory segment object (Operation 1006). The system accesses the memory segment object pursuant to the instructions of a program instance. Example source code corresponding to the instructions of an example program instance is provided below. In the example provided below, the program requests a memory segment object named “segment.” To this end, the program of this example calls a static factory method of a memory segment interface. In this example, the program requests a memory segment object that is backed by a heap-allocated integer array object. In other words, the program requests a domestic memory segment object in this example.

MemorySegment segment = MemorySegment.ofArray(new int[ ]
{3, 4, 0, 0});

In an example embodiment, the system generates an interface object that wraps an externally-allocated memory segment object (i.e., an external interface object) (Operation 1008). Stated differently, the system projects the contents of the region of memory backing memory segment object to an interface object. The system generates the external interface object pursuant to the instructions of a program instance. Example source code corresponding to the instructions of an example program instance is provided below. In the example provided below, the program requests an external interface object named “point” by calling a get method of a segment mapper interface on the mapper object that maps the interface to the group layout object. The program of this example specifies the preexisting memory segment object (i.e., segment) as an input parameter of the request. Furthermore, in this example, the program calls a setter method on the external interface object to store the value six to an x field of the external interface object, and the program calls a setter method on the external interface object to store the value eight to a y field of the external interface object.

Point point = mapper.get(segment); // Point[x=3, y=4]
point.x(6); // Point[x=6, y=4]
point.y(8); // Point[x=6, y=8]

In an example embodiment, the system may project the information represented by the external interface object to another region of memory (Operation 1010). Stated differently, the system may access another memory segment object, and the system may write the information represented by the external interface object to the region of memory backing the other memory segment object. The system accesses the other memory segment object and writes to the other region of memory pursuant to the instructions of a program instance. Example source code corresponding to the instructions of an example program instance is provided below. In the example below, the program requests another memory segment object named “otherSegment” by calling a method for allocating a new memory segment object from an arena object. In calling this method, the program of this example specifies that the other memory segment object should correspond to the specifications of a sequence layout object, and the program further specifies that (a) the group layout object (i.e., POINT) is the element layout object of the sequence layout object and (b) the group layout object is repeated twice within the sequence layout object. In addition, the program of this example calls a set method on the mapper object (i.e., mapper). In this example, the program specifies that the information represented by the external interface object (i.e., point) should be written to the other region of memory backing the other memory segment object (i.e., otherSegment) starting at the second index slot (i.e., 1) of the new memory segment object. Note that the second index slot corresponds to the second repetition of the group layout object within the sequence layout object.

MemorySegment otherSegment =
Arena.ofAuto( ).allocate(MemoryLayout.sequenceLayout(2, POINT));
mapper.setAtIndex(otherSegment, 1, point); // otherSegment: 0, 0, 6, 8

### 5.5 Example Inferences

This Section 5.5 demonstrates example inferences that may be drawn by the system in accordance with an example embodiment. At multiple points in this Section 5.5, example source code is provided to the reader for illustrative purposes. To provide consistent examples, the example source code is specified uniformly in Java. However, the techniques described in this Section 5.5 are equally applicable to other programing languages.

In an example embodiment, In an example embodiment, the system infers a reference type that is to be mapped to a memory layout object, and/or the system infers a memory layout object that is to be mapped to a reference type. The system may infer a reference type and/or a memory layout object while generating a mapper object that is requested by a program instance. For instance, the system may infer a compound layout object that is to be mapped to a reference type by a mapper object if a program instance's request for the mapper object does not specify a memory layout object as a parameter of the request. To demonstrate this scenario, example source code corresponding to the instructions of an example program instance is included below.

public record Point(int x, int y){ }
...
SegmentMapper<Point> recordMapper =
SegmentMapper.ofRecord(Point.class);

In the example provided above, the program instance specifies the record class “Point” as a parameter of the request for the mapper object “recordMapper.” However, the program instance of this example does not specify a memory layout object that is to be mapped to the record class “Point.” Accordingly, the system of this example infers a compound layout object based on the structure of “Point.” In particular, the system of this example infers that the record class “Point” should be mapped to a struct layout object that possesses two member layouts. The two member layout objects are value layout objects, and both value layout objects possess an integer carrier type. In this example, the system may name the first value layout object “x,” and the system may name the second value layout object “y;” however, note that these example names may be unnecessary for mapping purposes. If presented in source code, the compound layout object that is inferred by the system in this example might appear as is shown below.

structLayout(JAVA_INT.withName(“x”),
JAVA_INT.withName(“y”)).withName(“point”)

In an example embodiment, the system infers an inner reference type that is to be mapped to an inner compound layout object, and/or the system infers an inner compound layout object that is to be mapped to an inner reference type. The system may infer an inner reference type and/or inner compound layout object while generating a descendant mapper object (e.g., a child mapper object, a grandchild mapper object, etc.). For instance, the system may infer an inner reference type that is to be mapped to an inner compound layout object while generating a child mapper object. Recall that the system may generate a child mapper object while generating a parent mapper object that is requested by a program instance. To demonstrate this scenario, example source code corresponding to the instructions of an example program instance is included below. In this example, the program requests a parent mapper object “recordMapper” that maps the outer record class “Line” to the outer group layout object “LINE.”

public record Line(Point start, Object end){ }
static final GroupLayout POINT =
memoryLayout.structLayout(JAVA_INT.withName(“x”) ,
JAVA_INT.withName(“y”));
static final GroupLayout LINE = structlayout(POINT.withName(“start”) ,
POINT.withName(“end”));
SegmentMapper<Line> recordMapper = SegmentMapper.ofRecord(Line.class,
LINE);

In the example provided above, the outer group layout object “LINE” includes two inner group layout objects named “start” and “end.” The inner group layout objects “start” and “end” both have the same structure as the other group layout object “POINT” that is specified by the program instance. Note that the other group layout object “POINT” has two member layout objects named “x” and “y.” The member layout objects “x” and “y” are both value layout objects having an integer carrier type. In this example, the outer record class “Line” has two inner reference types named “start” and “end.” Thus, it may at first appear that the outer record class “Line” is a good match for the outer group layout object “LINE” in this example. However, note that the inner reference types are different; “start” is of type Point, and “end” is of type Object. Point is a java class that defines, as standard, an x field that accepts and integer and a y field that accepts an integer. Thus, the inner reference type “start” is a good match for the inner group layout object “start.” Object is also a standard java class; however, Object defines neither (a) an x field that accepts an integer nor (b) a y field that accepts an integer. Thus, the inner reference type “end” is not a good match for the inner group layout object “end,” because the inner reference type “end” (i.e., the Object type) is less specific than the inner group layout object “end.” Accordingly, the system of this example does not generate a child mapper object that attempts to map the inner reference type “end” to the inner group layout object “end.” Instead, the system of this example treats the inner reference type “end” as a missing element, and the system infers a new reference type that can be mapped to inner group layout object “end.” For instance, in this example, the system may generate a new reference type that has two fields that both accept an integer. In this example, the system may name the first field “x,” and the system may name the second field “y;” however, note that these example names may be unnecessary for mapping purposes. If presented in source code, the new reference type that is inferred by the system in this example might appear as is shown below.

syntheticHolder(int x, int y)

After inferring the new reference type in this example, the system may generate one child mapper object that maps the inner reference type “start” to the inner group layout object “start,” and the system may generate another child mapper object that maps the new reference type that is inferred by the system to the inner group layout object “end.” Based on these two child mapper objects, the system of this example may then return a parent mapper object that maps the outer record class “Line” to the outer group layout object “LINE.”

### 6. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

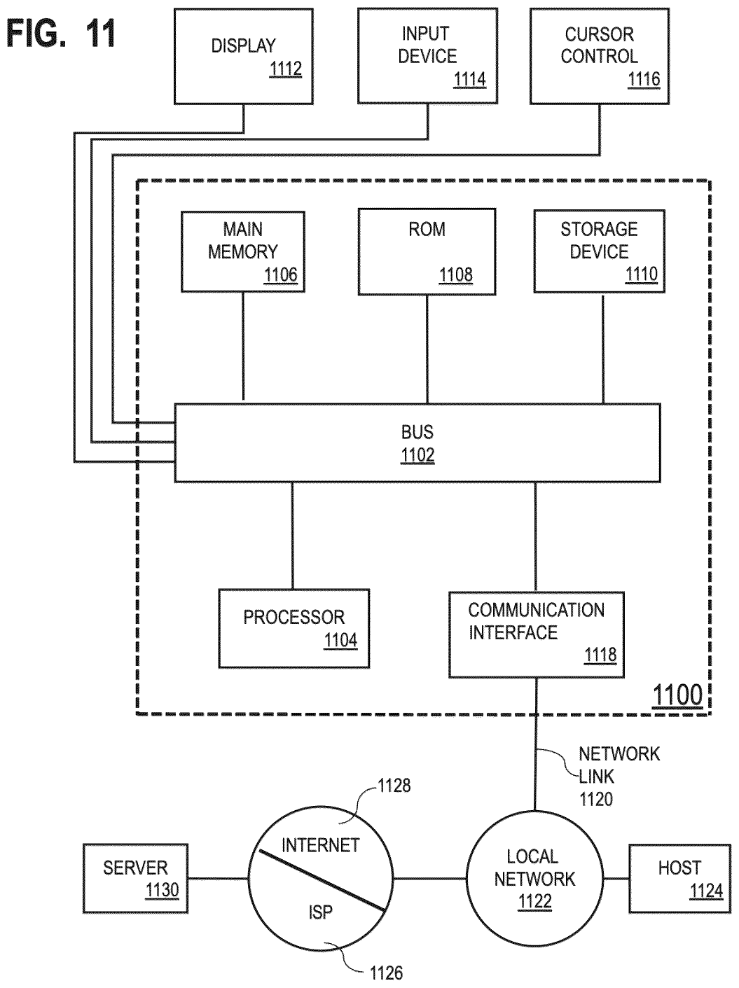

For example, FIG. 11 is a block diagram that illustrates a computer system 1100 upon which an embodiment of the disclosure may be implemented. Computer system 1100 includes a bus 1102 or other communication mechanism for communicating information, and a hardware processor 1104 coupled with bus 1102 for processing information. Hardware processor 1104 may be, for example, a general purpose microprocessor.

Computer system 1100 also includes a main memory 1106, such as a random access memory (RAM) or other dynamic storage device, coupled to bus 1102 for storing information and instructions to be executed by processor 1104. Main memory 1106 also may be used for storing temporary variables or other intermediate information during execution of instructions to be executed by processor 1104. Such instructions, when stored in non-transitory storage media accessible to processor 1104, render computer system 1100 into a special-purpose machine that is customized to perform the operations specified in the instructions.

Computer system 1100 further includes a read only memory (ROM) 1108 or other static storage device coupled to bus 1102 for storing static information and instructions for processor 1104. A storage device 1110, such as a magnetic disk or optical disk, is provided and coupled to bus 1102 for storing information and instructions.

Computer system 1100 may be coupled via bus 1102 to a display 1112, such as a cathode ray tube (CRT), for displaying information to a computer user. An input device 1114, including alphanumeric and other keys, is coupled to bus 1102 for communicating information and command selections to processor 1104. Another type of user input device is cursor control 1116, such as a mouse, a trackball, or cursor direction keys for communicating direction information and command selections to processor 1104 and for controlling cursor movement on display 1112. This input device typically has two degrees of freedom in two axes, a first axis (e.g., x) and a second axis (e.g., y), that allows the device to specify positions in a plane.

Computer system 1100 may implement the techniques described herein using customized hard-wired logic, one or more ASICs or FPGAs, firmware and/or program logic which in combination with the computer system causes or programs computer system 1100 to be a special-purpose machine. According to one embodiment, the techniques herein are performed by computer system 1100 in response to processor 1104 executing one or more sequences of one or more instructions contained in main memory 1106. Such instructions may be read into main memory 1106 from another storage medium, such as storage device 1110. Execution of the sequences of instructions contained in main memory 1106 causes processor 1104 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 1110. Volatile media includes dynamic memory, such as main memory 1106. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 1102. Transmission media can also take the form of acoustic or light waves, such as those generated during radio-wave and infra-red data communications.

Various forms of media may be involved in carrying one or more sequences of one or more instructions to processor 1104 for execution. For example, the instructions may initially be carried on a magnetic disk or solid state drive of a remote computer. The remote computer can load the instructions into its dynamic memory and send the instructions over a telephone line using a modem. A modem local to computer system 1100 can receive the data on the telephone line and use an infra-red transmitter to convert the data to an infra-red signal. An infra-red detector can receive the data carried in the infra-red signal and appropriate circuitry can place the data on bus 1102. Bus 1102 carries the data to main memory 1106, from which processor 1104 retrieves and executes the instructions. The instructions received by main memory 1106 may optionally be stored on storage device 1110 either before or after execution by processor 1104.

Computer system 1100 also includes a communication interface 1118 coupled to bus 1102. Communication interface 1118 provides a two-way data communication coupling to a network link 1120 that is connected to a local network 1122. For example, communication interface 1118 may be an integrated services digital network (ISDN) card, cable modem, satellite modem, or a modem to provide a data communication connection to a corresponding type of telephone line. As another example, communication interface 1118 may be a local area network (LAN) card to provide a data communication connection to a compatible LAN. Wireless links may also be implemented. In any such implementation, communication interface 1118 sends and receives electrical, electromagnetic or optical signals that carry digital data streams representing various types of information.

Network link 1120 typically provides data communication through one or more networks to other data devices. For example, network link 1120 may provide a connection through local network 1122 to a host computer 1124 or to data equipment operated by an Internet Service Provider (ISP) 1126. ISP 1126 in turn provides data communication services through the world wide packet data communication network now commonly referred to as the “Internet” 1128. Local network 1122 and Internet 1128 both use electrical, electromagnetic or optical signals that carry digital data streams. The signals through the various networks and the signals on network link 1120 and through communication interface 1118, which carry the digital data to and from computer system 1100, are example forms of transmission media.

Computer system 1100 can send messages and receive data, including program code, through the network(s), network link 1120 and communication interface 1118. In the Internet example, a server 1130 might transmit a requested code for an application program through Internet 1128, ISP 1126, local network 1122 and communication interface 1118.

The received code may be executed by processor 1104 as it is received, and/or stored in storage device 1110, or other non-volatile storage for later execution.

### 7. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer-readable media comprising instructions that, when executed by one or more hardware processors, cause performance of operations comprising:
accessing (a) a reference type and (b) a compound layout object for organizing regions of memory, wherein the reference type is to be mapped to the compound layout object;
generating a first plurality of mappings between (a) a first plurality of elements comprised within the reference type and (b) a first plurality of constituent layout objects associated with the compound layout object;
based, at least in part, on the first plurality of mappings, determining a first set of operations that extracts a dataset from a source region of memory and generates a target runtime object to represent the dataset,
wherein (a) the source region of memory is organized in accordance with the compound layout object, and (b) the target runtime object is associated with the reference type; and
based, at least in part, on a first region of memory that stores a first dataset in accordance with the compound layout object, executing the first set of operations to generate a first runtime object to represent the first dataset, wherein the first runtime object is associated with the reference type.

2. The one or more non-transitory computer-readable media of claim 1, wherein the operations further comprise:
based, at least in part, on the first plurality of mappings, determining a second set of operations that writes the dataset to a target region of memory based on a source runtime object representing the dataset,
wherein (a) the second set of operations writes the dataset to the target region of memory in accordance with the compound layout object and (b) the source runtime object is associated with the reference type; and
based, at least in part, on a second runtime object representing a second dataset, executing the second set of operations to write the second dataset to a second region of memory in accordance with the compound layout object, wherein the second runtime object is associated with the reference type.

3. The one or more non-transitory computer-readable media of claim 1, wherein the operations further comprise:
based, at least in part, on a second region of memory that stores a second dataset in accordance with the compound layout object, executing the first set of operations to generate a second runtime object to represent the second dataset, wherein the second runtime object is associated with the reference type.

4. The one or more non-transitory computer-readable media of claim 2, wherein the first plurality of elements comprises an inner reference type, wherein the inner reference type comprises a second plurality of elements, wherein the first plurality of constituent layout objects comprises an inner compound layout object, wherein the inner compound layout object is associated with a second plurality of constituent layout objects, and wherein generating the first plurality of mappings comprises generating a mapping between the inner reference type and the inner compound layout object.

5. The one or more non-transitory computer-readable media of claim 4, wherein the operations further comprise:
prior to executing the first set of operations:
generating a second plurality of mappings between (a) the second plurality of elements and (b) the second plurality of constituent layout objects; and
based, at least in part, on the second plurality of mappings, determining at least one of:
(a) a third set of operations that extracts an inner dataset from the source region of memory and generates an inner target runtime object associated with the inner reference type to represent the inner dataset, wherein the first set of operations comprises the third set of operations; or
(b) a fourth set of operations that writes the inner dataset to the target region of memory based on an inner source runtime object representing the inner dataset,
wherein (a) the fourth set of operations writes inner dataset to the target region of memory in accordance with the inner compound layout object, (b) the inner source runtime object is associated with the inner reference type, and (c) the second set of operations comprises the fourth set of operations.

6. The one or more non-transitory computer-readable media of claim 1, wherein the operations further comprise:
performing reflective analysis on the reference type to access a first plurality of element names respectively corresponding to the first plurality of elements, wherein the first plurality of element names comprises a particular element name associated with a particular element comprised within the first plurality of elements;
retrieving a first plurality of layout names from the compound layout object, the first plurality of layout names respectively corresponding to the first plurality of constituent layout objects, wherein the first plurality of layout names comprises a particular layout name associated with a particular constituent layout object comprised within the first plurality of constituent layout objects; and
matching the particular element to the particular constituent layout object based on determining at least one of:
(a) the particular element name corresponds to the particular layout name; or
(b) a first data type of the particular element corresponds to a second data type of the particular constituent layout object; and
responsive to matching the particular element to the particular constituent layout object, generating a mapping between the particular element and the particular constituent layout object, wherein the mapping between the particular element and the particular constituent layout object is comprised within the first plurality of mappings.

7. The one or more non-transitory computer-readable media of claim 1, wherein the compound layout object is a group layout object, wherein the reference type is a record class or an interface, wherein the first runtime object is a record instance and/or an interface object, wherein the first runtime object is comprised within a managed memory area, wherein the first region of memory is comprised within a foreign memory area, wherein managed data stored to the managed memory area is associated with a first programming language, and wherein foreign data stored to the foreign memory area is associated with a second programming language.

8. The one or more non-transitory computer-readable media of claim 2, wherein the first region of memory is represented by a first memory segment object, wherein the second region of memory is represented by a second memory segment object, wherein the first memory segment object and the second memory segment object are associated with a memory segment reference type, wherein determining the first set of operations further comprises generating a first method handle object to a first method of the memory segment reference type, wherein the first method handle object specifies a value layout object as a first input parameter to the first method of the memory segment reference type, wherein determining the second set of operations further comprises generating a second method handle object to a second method of the memory segment reference type, wherein the second method handle object specifies the value layout object as a second input parameter to the second method, and wherein the value layout object is a constituent layout object comprised within the first plurality of constituent layout objects.

9. The one or more non-transitory computer-readable media of claim 5, wherein the third set of operations are defined by a third method, wherein the fourth set of operations are defined by a fourth method, wherein determining the first set of operations further comprises generating a first method handle object to the third method, wherein determining the second set of operations comprises determining a second method handle object to the fourth method.

10. The one or more non-transitory computer-readable media of claim 1, wherein accessing (a) the reference type and (b) the compound layout object for organizing regions of memory comprises performing one of:
(a) responsive to accessing the reference type: determining the compound layout object based, at least in part, on the first plurality of elements comprised within the reference type; or
(b) responsive to accessing the compound layout object: determining the reference type based, at least in part, on the first plurality of constituent layout objects associated with the compound layout object.

11. A method comprising:
accessing (a) a reference type and (b) a compound layout object for organizing regions of memory, wherein the reference type is to be mapped to the compound layout object;
generating a first plurality of mappings between (a) a first plurality of elements comprised within the reference type and (b) a first plurality of constituent layout objects associated with the compound layout object;
based, at least in part, on the first plurality of mappings, determining a first set of operations that extracts a dataset from a source region of memory and generates a target runtime object to represent the dataset,
wherein (a) the source region of memory is organized in accordance with the compound layout object, and (b) the target runtime object is associated with the reference type; and
based, at least in part, on a first region of memory that stores a first dataset in accordance with the compound layout object, executing the first set of operations to generate a first runtime object to represent the first dataset, wherein the first runtime object is associated with the reference type;
wherein the method is performed by at least one device including a hardware processor.

12. The method of claim 11, further comprising:
based, at least in part, on the first plurality of mappings, determining a second set of operations that writes the dataset to a target region of memory based on a source runtime object representing the dataset,
wherein (a) the second set of operations writes the dataset to the target region of memory in accordance with the compound layout object and (b) the source runtime object is associated with the reference type; and
based, at least in part, on a second runtime object representing a second dataset, executing the second set of operations to write the second dataset to a second region of memory in accordance with the compound layout object, wherein the second runtime object is associated with the reference type.

13. The method of claim 11, further comprising:
based, at least in part, on a second region of memory that stores a second dataset in accordance with the compound layout object, executing the first set of operations to generate a second runtime object to represent the second dataset, wherein the second runtime object is associated with the reference type.

14. The method of claim 12, wherein the first plurality of elements comprises an inner reference type, wherein the inner reference type comprises a second plurality of elements, wherein the first plurality of constituent layout objects comprises an inner compound layout object, wherein the inner compound layout object is associated with a second plurality of constituent layout objects, and wherein generating the first plurality of mappings comprises generating a mapping between the inner reference type and the inner compound layout object.

15. The method of claim 14, wherein the operations further comprise:
prior to executing the first set of operations:
generating a second plurality of mappings between (a) the second plurality of elements and (b) the second plurality of constituent layout objects; and
based, at least in part, on the second plurality of mappings, determining at least one of:
(a) a third set of operations that extracts an inner dataset from the source region of memory and generates an inner target runtime object associated with the inner reference type to represent the inner dataset, wherein the first set of operations comprises the third set of operations; or
(b) a fourth set of operations that writes the inner dataset to the target region of memory based on an inner source runtime object representing the inner dataset,
wherein (a) the fourth set of operations writes inner dataset to the target region of memory in accordance with the inner compound layout object, (b) the inner source runtime object is associated with the inner reference type, and (c) the second set of operations comprises the fourth set of operations.

16. The method of claim 11, further comprising:
performing reflective analysis on the reference type to access a first plurality of element names respectively corresponding to the first plurality of elements, wherein the first plurality of element names comprises a particular element name associated with a particular element comprised within the first plurality of elements;
retrieving a first plurality of layout names from the compound layout object, the first plurality of layout names respectively corresponding to the first plurality of constituent layout objects, wherein the first plurality of layout names comprises a particular layout name associated with a particular constituent layout object comprised within the first plurality of constituent layout objects; and
matching the particular element to the particular constituent layout object based on determining at least one of:
(a) the particular element name corresponds to the particular layout name; or
(b) a first data type of the particular element corresponds to a second data type of the particular constituent layout object; and
responsive to matching the particular element to the particular constituent layout object, generating a mapping between the particular element and the particular constituent layout object, wherein the mapping between the particular element and the particular constituent layout object is comprised within the first plurality of mappings.

17. The method of claim 11, wherein the compound layout object is a group layout object, wherein the reference type is a record class or an interface, wherein the first runtime object is a record instance and/or an interface object, wherein the first runtime object is comprised within a managed memory area, wherein the first region of memory is comprised within a foreign memory area, wherein managed data stored to the managed memory area is associated with a first programming language, and wherein foreign data stored to the foreign memory area is associated with a second programming language.

18. The method of claim 12, wherein the first region of memory is represented by a first memory segment object, wherein the second region of memory is represented by a second memory segment object, wherein the first memory segment object and the second memory segment object are associated with a memory segment reference type, wherein determining the first set of operations further comprises generating a first method handle object to a first method of the memory segment reference type, wherein the first method handle object specifies a value layout object as a first input parameter to the first method of the memory segment reference type, wherein determining the second set of operations further comprises generating a second method handle object to a second method of the memory segment reference type, wherein the second method handle object specifies the value layout object as a second input parameter to the second method, and wherein the value layout object is a constituent layout object comprised within the first plurality of constituent layout objects.

19. The method of claim 11, wherein accessing (a) the reference type and (b) the compound layout object for organizing regions of memory comprises performing one of:
(a) responsive to accessing the reference type: determining the compound layout object based, at least in part, on the first plurality of elements comprised within the reference type; or
(b) responsive to accessing the compound layout object: determining the reference type based, at least in part, on the first plurality of constituent layout objects associated with the compound layout object.

20. A system comprising:
at least one device including a hardware processor;
the system being configured to perform operations comprising:
accessing (a) a reference type and (b) a compound layout object for organizing regions of memory, wherein the reference type is to be mapped to the compound layout object;
generating a first plurality of mappings between (a) a first plurality of elements comprised within the reference type and (b) a first plurality of constituent layout objects associated with the compound layout object;
based, at least in part, on the first plurality of mappings, determining a first set of operations that extracts a dataset from a source region of memory and generates a target runtime object to represent the dataset,
wherein (a) the source region of memory is organized in accordance with the compound layout object, and (b) the target runtime object is associated with the reference type; and
based, at least in part, on a first region of memory that stores a first dataset in accordance with the compound layout object, executing the first set of operations to generate a first runtime object to represent the first dataset, wherein the first runtime object is associated with the reference type.
